(19) United States
(12) Patent Application Publication
(10) Pub. No.: US 2024/0349141 A1
(43) Pub. Date: Oct. 17, 2024

(54) COMMUNICATION DEVICE AND COMMUNICATION METHOD

(71) Applicant: SONY GROUP CORPORATION, TOKYO (JP)

(72) Inventor: HIROKI MATSUDA, TOKYO (JP)

(21) Appl. No.: 18/579,701

(22) PCT Filed: Mar. 30, 2022
(86) PCT No.: PCT/JP2022/015925

§ 371 Date: Jan. 16, 2024

(30) Foreign Application Priority Data
Aug. 6, 2021 (JP) 2021-129868

(51) Int. Cl. H04W 36/00

(52) U.S. Cl. CPC H04W 36/00837

(57) ABSTRACT

A communication device (40) is provided. A communication device (40) includes a transceiver (41) and a processor (43). The processor (43) receives, via the transceiver (41), execution trigger information regarding a trigger for executing a handover. After executing a detachment procedure on a first non-terrestrial station (30) having a first cell, the processor (43) performs an evaluation for the trigger using the execution trigger information. The processor (43) connects to a second non-terrestrial station (30) having a second cell different from the first cell on a basis of the evaluation.

### FIELD

The present disclosure relates to a communication device and a communication method.

### BACKGROUND

In response to increasing demands for wide area coverage, connection stability, and the like, consideration of a non-terrestrial network (NTN), in which a radio network is provided from a device floating in the air or space, has started. In the non-terrestrial network, the radio network is provided to a terminal device via a satellite station or an aircraft. In addition, the non-terrestrial network uses the same radio access scheme as that of a terrestrial network to facilitate integrated operation of the terrestrial network and the non-terrestrial network. Low earth orbiting and medium earth orbiting satellites in the non-terrestrial network move at high speed in the sky. Therefore, it is considered to always provide a communication service to the terminal device by a plurality of satellites forming a constellation.

On the other hand, provision of the NTN service to an Internet of Things (IoT) terminal is also being considered. Non Patent Literature 1 discloses a technology related to communication between an IoT terminal and a small satellite.

### CITATION LIST

### Non Patent Literature

Non Patent Literature 1: R1-2009098, Gatehouse, Sateliot, “Discussion on scenarios applicable to NB-IoT NTN”, 3GPP TSG RAN WG1 #103-e E-meeting, 26 Oct.-13 Nov. 2020, [Online], [Searched on Jul. 27, 2021], Internet <https://www.3gpp.org/ftp/tsg_ran/WG1_RL1/TSGR1_103-e/Docs/R1-2009098.zip>

### SUMMARY

### Technical Problem

The small satellite described above forms a small cell and performs communication. Therefore, a communication service provided by the non-terrestrial station such as the small satellite becomes an intermittent service. In a case where the non-terrestrial station intermittently provides the communication service to the terminal device, the time during which the terminal device can communicate with the non-terrestrial station is limited.

Therefore, in the case where the non-terrestrial station that provides the intermittent communication service and the terminal device communicate with each other as described above, a technique for more efficiently performing communication in a short time is required.

Therefore, the present disclosure proposes a configuration capable of more efficiently performing communication in a short time.

Note that the above problem or object is merely one of a plurality of problems or objects that can be solved or achieved by the plurality of embodiments disclosed in the present specification.

### Solution to Problem

According to the present disclosure, a communication device is provided. A communication device includes a transceiver and a processor. The processor (43) receives, via the transceiver, execution trigger information regarding a trigger for executing a handover. After executing a detachment procedure on a first non-terrestrial station having a first cell, the processor performs an evaluation for the trigger using the execution trigger information. The processor connects to a second non-terrestrial station having a second cell different from the first cell on a basis of the evaluation.

### BRIEF DESCRIPTION OF DRAWINGS

FIG. 1 is a diagram illustrating a configuration example of a communication system according to an embodiment of the present disclosure.

FIG. 2 is a diagram illustrating an example of a radio network provided by the communication system.

FIG. 3 is a diagram illustrating an overview of a satellite communication provided by the communication system.

FIG. 4 is a diagram illustrating an example of a cell constituted by a non-geostationary satellite.

FIG. 5 is a diagram illustrating a configuration example of a management device according to the embodiment of the present disclosure.

FIG. 6 is a diagram illustrating a configuration example of a terrestrial station according to the embodiment of the present disclosure.

FIG. 7 is a diagram illustrating a configuration example of a satellite station according to the embodiment of the present disclosure.

FIG. 8 is a diagram illustrating a configuration example of a terminal device according to the embodiment of the present disclosure.

FIG. 9 is a diagram for describing an example of satellite communication according to the embodiment of the present disclosure.

FIG. 10 is a sequence diagram for describing an example of a flow of a handover.

FIG. 11 is a sequence diagram for describing another example of the flow of the handover.

FIG. 12 is a sequence diagram illustrating an example of a flow of handover processing according to the embodiment of the present disclosure.

FIG. 13 is a sequence diagram illustrating another example of the flow of the handover processing according to the embodiment of the present disclosure.

FIG. 14 is a sequence diagram illustrating an example of a flow of Conditional handover processing according to the embodiment of the present disclosure.

FIG. 15 is a sequence diagram illustrating another example of the flow of the Conditional handover processing according to the embodiment of the present disclosure.

### DESCRIPTION OF EMBODIMENTS

Hereinbelow, embodiments of the present disclosure will be described in detail with reference to the accompanying drawings. Note that, in the present specification and the drawings, components having substantially the same functional configurations are labeled with the same reference signs, and redundant description is omitted.

In addition, in the present specification and the drawings, a plurality of components having substantially the same functional configurations may be distinguished by attaching different numerals or alphabets to the ends of the same reference signs. For example, a plurality of components having substantially the same functional configurations are distinguished as terminal devices 401, 402, and 403 as necessary. However, in a case where it is not particularly necessary to distinguish the plurality of components having substantially the same functional configurations from each other, only the same reference signs are attached. For example, in a case where it is not necessary to particularly distinguish the terminal devices 401, 402, and 403, they are simply referred to as terminal devices 40.

Furthermore, in the present specification and the drawings, description may be provided by illustrating specific values, but the values are illustrative only, and other values may be applied.

Furthermore, resources in the present specification and the drawings are represented as Frequency, Time, Resource Element (including REG, CCE, and CORESET), Resource Block, Bandwidth Part, Component Carrier, Symbol, Sub-Symbol, Slot, Mini-Slot, Subslot, Subframe, Frame, PRACH occasion, Occasion, Code, Multi-access physical resource, Multi-access signature, Subcarrier Spacing (Numerology), and the like.

One or a plurality of embodiments (including examples and modification examples) described below can each be carried out independently. On the other hand, at least some of the plurality of embodiments described below may appropriately be combined with at least some of other embodiments. The plurality of embodiments may include novel features different from each other. Therefore, the plurality of embodiments can contribute to solving different objects or problems, and can exhibit different effects.

### 1. OVERVIEW

A radio access technology (RAT) such as Long Term Evolution (LTE) and New Radio (NR) has been considered in 3rd Generation Partnership Project (3GPP). LTE and NR are types of cellular communication technology, and enable mobile communication of a terminal device by arranging a plurality of cell-like areas each covered by a base station. At this time, a single base station may manage a plurality of cells.

Note that, in the following description, “LTE” includes LTE-Advanced (LTE-A), LTE-Advanced Pro (LTE-A Pro), and Evolved Universal Terrestrial Radio Access (EUTRA). In addition, NR includes New Radio Access Technology (NRAT) and Further EUTRA (FEUTRA). Note that a single base station may manage a plurality of cells. In the following description, a cell corresponding to LTE is referred to as an LTE cell, and a cell corresponding to NR is referred to as an NR cell.

NR is a radio access technology (RAT) in a generation (fifth generation) subsequent to LTE. NR is a radio access technology that can support various use cases including Enhanced Mobile Broadband (eMBB), Massive Machine Type Communications (mMTC), and Ultra-Reliable and Low Latency Communications (URLLC). NR has been considered aiming at a technical framework that supports usage scenarios, requirement conditions, arrangement scenarios, and the like in these use cases.

Furthermore, in NR, consideration of a non-terrestrial network has started in response to increasing demands for wide area coverage, connection stability, and the like. In the non-terrestrial network, a radio network is scheduled to be provided to a terminal device via a base station other than a terrestrial station, such as a satellite station and an aircraft station. The base station other than the terrestrial station is referred to as a non-terrestrial station or a non-terrestrial base station. The radio network provided by the terrestrial station is referred to as a terrestrial network (TN). By using the same radio access scheme for the terrestrial network and the non-terrestrial network, integrated operation of the terrestrial network and the non-terrestrial network becomes possible.

As described above, in IoT data communication using the non-terrestrial network, communication using a small mobile satellite has been considered. For example, one feature of the small satellite also referred to as Cube-sat, micro-satellite, or the like is to provide an intermittent communication service to the terminal device.

Therefore, in the case where the small satellite that provides the intermittent communication service and the terminal device communicate with each other in this manner, a technique for more efficiently performing communication in a short time is required. For example, applying a handover in the small satellite communication is effective for smooth inter-cell movement.

However, in a case where the conventional handover is applied in the small satellite communication, in which the intermittent communication is performed, there arises a problem that communication with a small satellite as a handover source is stopped before the terminal device starts communication with (attaches to) a small satellite as a handover target.

Under such circumstances, the present embodiment solves this problem by the following means.

For example, a communication system according to the present embodiment is a mobile satellite communication system in which a terminal device communicates with a small mobile satellite. The terminal device included in the communication system receives execution trigger information regarding a trigger for executing a handover. Then, after executing a detachment procedure on a small satellite as a handover source (an example of a first base station) being connected, the terminal device performs an evaluation for the trigger using the execution trigger information. The terminal device connects to a small satellite as a handover target (an example of a second base station) on the basis of a result of the evaluation for the trigger.

As a result, the terminal device can be connected to the small satellite as the handover target in a state where the terminal device cannot communicate with the small satellite as the handover source, and smooth inter-cell movement can be performed. Therefore, the terminal device can perform communication more efficiently in a short time.

The overview of the present embodiment has been described above, and the communication system according to the present embodiment will be described in detail below.

### 2. CONFIGURATION OF COMMUNICATION SYSTEM

A communication system 1 is a Bent-pipe (Transparent) type mobile satellite communication system. The communication system 1 is a cellular communication system using a radio access technology such as LTE and NR, and provides radio communication via a satellite station to a terrestrial terminal device. A radio access scheme used in the communication system 1 is not limited to LTE and NR, and may be another radio access scheme such as Wideband Code Division Multiple Access (W-CDMA) and Code Division Multiple Access 2000 (cdma2000).

Hereinbelow, a configuration of the communication system 1 will specifically be described.

### <2.1. Overall Configuration of Communication System>

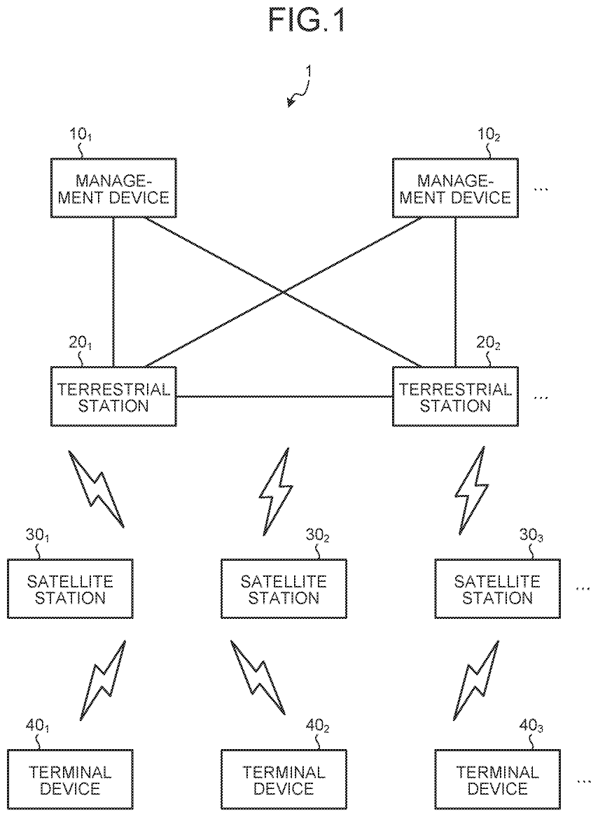

FIG. 1 is a diagram illustrating a configuration example of the communication system 1 according to an embodiment of the present disclosure. The communication system 1 includes a management device 10, a terrestrial station 20, a satellite station 30, and a terminal device 40. The communication system 1 provides a user with a radio network enabling the user to perform mobile communication as radio communication devices constituting the communication system 1 operate in cooperation. The radio network of the present embodiment includes, for example, a radio access network and a core network. Note that, in the present embodiment, the radio communication device is a device having a function of the radio communication, and in the example of FIG. 1, the terrestrial station 20, the satellite station 30, and the terminal device 40 are the devices.

The communication system 1 may include a plurality of management devices 10, a plurality of terrestrial stations 20, a plurality of satellite stations 30, and a plurality of terminal devices 40. In the example of FIG. 1, the communication system 1 includes management devices 10₁ and 10₂, and the like as the management device 10, and terrestrial stations 20₁ and 20₂, and the like as the terrestrial station 20. The communication system 1 also includes satellite stations 30₁ and 30₂, and the like as the satellite station 30, and terminal devices 40₁, 40₂, and 40₃, and the like as the terminal device 40.

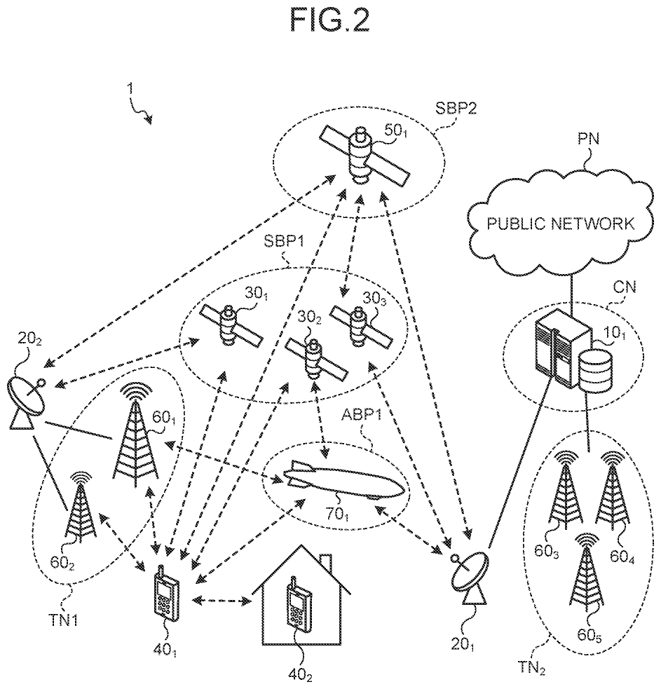

FIG. 2 is a diagram illustrating an example of the radio network provided by the communication system 1. The terrestrial station 20 (satellite station 30) and a base station 60 each constitute a cell. The cell is an area in which the radio communication is available. The cell may be any of a macro cell, a micro cell, a femto cell, and a small cell. Note that the communication system 1 may be configured so that a single base station (satellite station) may manage a plurality of cells, or a plurality of base stations may manage one cell.

In the example of FIG. 2, the base stations 60₁ and 60₂ constitute a terrestrial network TN1, and the base stations 60₃, 60₄, and 60₅ constitute a terrestrial network TN2. The terrestrial network TN1 and the terrestrial network TN2 are, for example, networks operated by a radio communication carrier such as a telephone company. The terrestrial network TN1 and the terrestrial network TN2 may be operated by different radio communication carriers, or may be operated by the same radio communication carrier. The terrestrial network TN1 and the terrestrial network TN2 can be regarded as one terrestrial network.

The terrestrial network TN1 and the terrestrial network TN2 are each connected to the core network. In the example of FIG. 2, the base stations 60 constituting the terrestrial network TN2 are connected to, for example, a core network CN constituted by the management device 10₁ and the like. In a case where the radio access scheme of the terrestrial network TN2 is LTE, that of the core network CN is EPC. Also, in a case where the radio access scheme of the terrestrial network TN2 is NR, that of the core network CN is 5GC. Of course, the radio access scheme of the core network CN is not limited to EPC or 5GC, and the core network CN may be a core network of another radio access scheme. In the example of FIG. 2, the terrestrial network TN1 is not connected to any core network, but the terrestrial network TN1 may be connected to the core network CN. Furthermore, the terrestrial network TN1 may be connected to a not-illustrated core network different from the core network CN.

The core network CN includes a gateway device, an interconnecting gateway switch, and the like, and is connected to a public network PN via the gateway device. The public network PN is, for example, a public data network such as the Internet, a regional IP network, and a telephone network (a mobile telephone network, a fixed telephone network, or the like). The gateway device is, for example, a server device connected to the Internet, the regional IP network, or the like. The interconnecting gateway switch is, for example, a switch connected to the telephone network of the telephone company. The management device 10₁ may have a function as the gateway device or the interconnecting gateway switch.

The satellite stations 30 and 50 and an aircraft station 70 illustrated in FIG. 2 are each a non-terrestrial station such as a satellite station and an aircraft station. A satellite station group (or a satellite station) constituting a non-terrestrial network is referred to as a spaceborne platform. In addition, an aircraft station group (or an aircraft station) constituting a non-terrestrial network is referred to as an airborne platform. In the example of FIG. 2, the satellite stations 30₁, 30₂, and 30₃ constitute a spaceborne platform SBP1, and the satellite station 50₁ constitutes a spaceborne platform SBP2. In addition, the aircraft station 70₃ constitutes an airborne platform ABP1.

The terminal device 40 can communicate with both the terrestrial station and the non-terrestrial station. In the example of FIG. 2, the terminal device 40₁ can communicate with the terrestrial station constituting the terrestrial network TN1. In addition, the terminal device 40₁ can communicate with the non-terrestrial stations respectively constituting the spaceborne platforms SBP1 and SBP2. The terminal device 40₁ can also communicate with the non-terrestrial station constituting the airborne platform ABP1. Note that the terminal device 40₁ may be able to directly communicate with another terminal device 40 (the terminal device 40₂ in the example of FIG. 2).

The non-terrestrial station such as the satellite station 30 may be connectable to the terrestrial network or the core network via a relay station. The non-terrestrial stations can directly communicate with each other without interposing a relay station.

The relay station is, for example, an aeronautical station or an earth station. The aeronautical station is a radio station installed on the ground or a moving body moving on the ground in order to communicate with the aircraft station. Furthermore, the earth station is a radio station located on the earth (including in the air) in order to communicate with the satellite station (space station). The earth station may be a large earth station or a small earth station such as a Very Small Aperture Terminal (VSAT). Note that the earth station may be a VSAT control earth station (also referred to as a primary station or a HUB station) or a VSAT earth station (also referred to as a subordinate station). Furthermore, the earth station may be a radio station installed in a moving body moving on the ground. For example, an Earth Station on board Vessel (ESV) can be cited as the earth station mounted on a ship. Furthermore, the earth station may include an aircraft earth station that is installed in an aircraft (including a helicopter) and communicates with a satellite station. Furthermore, the earth station may include an aeronautical earth station that is installed in a moving body moving on the ground and communicates with the aircraft earth station via a satellite station. Note that the relay station may be a portable movable radio station that communicates with the satellite station or the aircraft station. The relay station can be regarded as a part of the communication system 1.

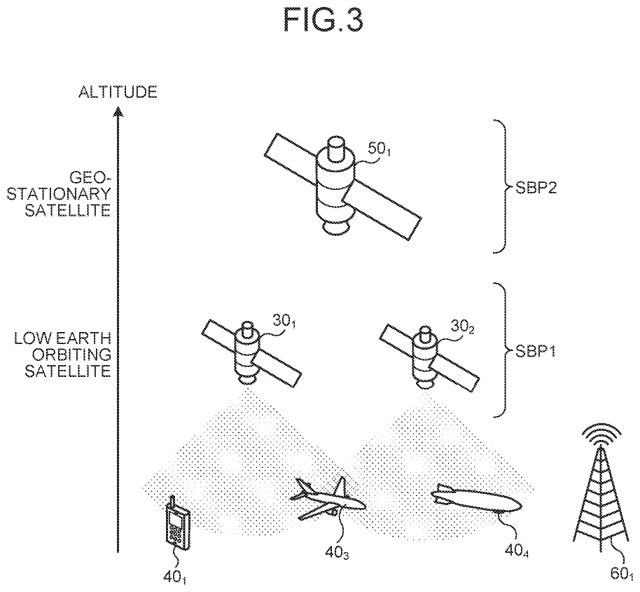

Each of the devices constituting the spaceborne platforms SBP1 and SBP2 performs satellite communication with the terminal device 40. The satellite communication is radio communication between the satellite station and the communication device. FIG. 3 is a diagram illustrating an overview of the satellite communication provided by the communication system 1. The satellite station mainly includes a geostationary satellite station and a low earth orbiting satellite station.

The geostationary satellite station is located at an altitude of approximately 35786 km and revolves around the earth at the same speed as the rotation speed of the earth. In the example of FIG. 3, the satellite station 50₁ constituting the spaceborne platform SBP2 is the geostationary satellite station. The geostationary satellite station has a relative velocity with the terminal device 40 on the ground of substantially 0, and is observed as if stationary from the terminal device 40 on the ground. The satellite station 50₁ performs the satellite communication with the terminal devices 40₁, 40₃, 40₄, and the like located on the earth.

The low earth orbiting satellite station is a satellite station that orbits at a lower altitude than the geostationary satellite station or a medium earth orbiting satellite station. The low earth orbiting satellite station is, for example, a satellite station located at an altitude of 500 km to 2000 km. In the example of FIG. 3, the satellite stations 30₂ and 30₃ constituting the spaceborne platform SBP1 are the low earth orbiting satellite stations. Note that FIG. 3 illustrates only two satellite stations, namely, the satellite station 30₂ and the satellite station 30₃, as satellite stations constituting the spaceborne platform SBP1. However, actually, as the satellite stations constituting the spaceborne platform SBP1, two or more (for example, several tens to several thousands of) satellite stations 30 form a low earth orbiting satellite constellation. Unlike the geostationary satellite station, the low earth orbiting satellite station has a relative velocity with the terminal device 40 on the ground, and is observed as if moving from the terminal device 40 on the ground. The satellite stations 30₂ and 30₃ constitute cells, respectively, and perform satellite communication with the terminal devices 40₁, 40₃, 40₄, and the like located on the earth.

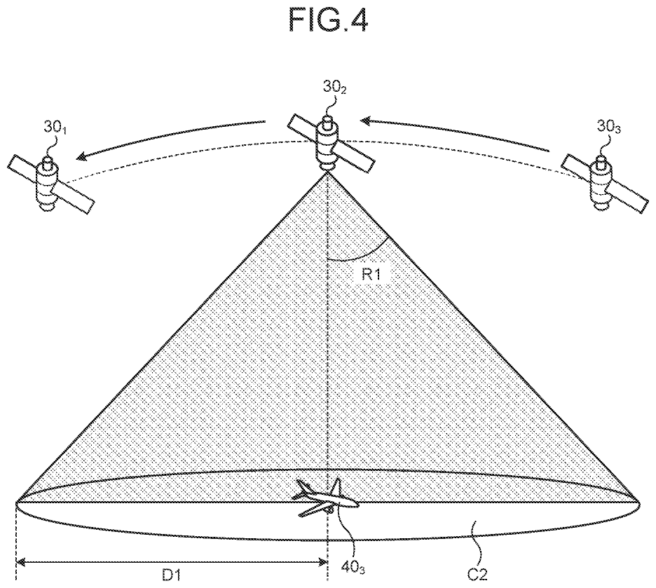

FIG. 4 is a diagram illustrating an example of the cell constituted by a non-geostationary satellite. FIG. 4 illustrates a cell C2 formed by the satellite station 30₂, which is a low earth orbiting satellite station. The satellite station orbiting in a low orbit communicates with the terminal device 40 on the ground with a predetermined directivity toward the ground. For example, an angle R1 illustrated in FIG. 4 is 40°. In the case of FIG. 4, a radius D1 of the cell C2 formed by the satellite station 30₂ is, for example, 1000 km. The low earth orbiting satellite station moves with a constant velocity. In a case where it becomes difficult for the low earth orbiting satellite station to provide satellite communication to the terminal device 40 on the ground, a subsequent low earth orbiting satellite station (neighbor satellite station) provides satellite communication. In the case of the example of FIG. 4, in a case where it becomes difficult for the satellite station 30₂ to provide satellite communication to the terminal device 40 on the ground, the subsequent satellite station 30₃ provides satellite communication. Note that the values of the angle R1 and the radius D1 described above are merely examples, and are not limited to the above.

As described above, the medium earth orbiting satellite and the low earth orbiting satellite move on the orbit at a very high speed in the sky, and for example, the low earth orbiting satellite at an altitude of 600 km moves on the orbit at a speed of 7.6 km/S. The low earth orbiting satellite forms a cell (or beam) having a radius of several tens to several hundreds of kilometers on the ground, but since the cell formed on the ground also moves in accordance with the movement of the satellite, the handover may be required even if the terminal device 40 on the ground does not move. For example, assuming a case where the cell diameter formed on the ground is 50 km and the terminal device 40 on the ground is not moving, the handover occurs in about six to seven seconds.

As described above, the terminal device 40 can perform radio communication using a non-terrestrial network. Furthermore, the satellite station 30 of the communication system 1 constitutes a non-terrestrial network. As a result, the communication system 1 can extend the service to the terminal device 40 located in an area that cannot be covered by the terrestrial network. For example, the communication system 1 can provide public safety communication and critical communication to a communication device such as an Internet of Things (IoT) device and a Machine Type Communications (MTC) device. In addition, since the use of the non-terrestrial network improves service reliability and recoverability, the communication system 1 can reduce the vulnerability of the service to physical attacks or natural disasters. Furthermore, the communication system 1 can achieve service connection to an airplane passenger and an aircraft terminal device such as a drone, and service connection to a mobile terminal device such as a ship and a train. In addition, the communication system 1 can provide A/V content, group communication, an IoT broadcast service, a software download service, a high-efficiency multicast service such as an emergency message, a high-efficiency broadcast service, and the like. Furthermore, the communication system 1 can also achieve traffic offloading between the terrestrial network and the non-terrestrial network. In order to achieve these, it is desirable that the non-terrestrial network provided by the communication system 1 is subjected to operation integration with the terrestrial network provided by the communication system 1 in an upper layer. In addition, it is desirable that the non-terrestrial network provided by the communication system 1 has a common radio access scheme to that of the terrestrial network provided by the communication system 1.

Note that the devices in the drawings may be considered as devices in a logical sense. That is, some functions of the devices in the drawings may be fulfilled by a virtual machine (VM), a container, Docker, or the like, and may be implemented on the same physical hardware.

In addition, in the present embodiment, the terrestrial station can be rephrased as a base station. The satellite station can be rephrased as a relay station. In a case where the satellite station has a function as a base station, the satellite station can be rephrased as a base station.

Note that, in LTE, the base station may be referred to as Evolved Node B (eNodeB) or eNB. Also, in NR, the base station may be referred to as gNodeB or gNB. Further, in LTE and NR, the terminal device 40 (also referred to as a mobile station or a terminal) may be referred to as user equipment (UE). Note that the terminal device 40 is a type of communication device, and is also referred to as a mobile station, a mobile station, or a terminal.

In the present embodiment, the concept of the communication device includes not only a portable mobile device (terminal device 40) such as a mobile terminal but also a device installed in a structure or a moving body. The structure or the moving body itself may be regarded as a communication device. Furthermore, the concept of the communication device includes not only the terminal device 40 but also a base station and a relay device. The communication device is a type of processing device and information processing device. Furthermore, the communication device can be rephrased as a transmission device or a reception device.

Hereinbelow, a configuration of each of the devices constituting the communication system 1 will specifically be described. Note that the configuration of each of the devices described below is merely an example. The configuration of each of the devices may be different from the following configuration.

### <2.2. Configuration of Management Device>

Next, a configuration of the management device 10 will be described.

The management device 10 is a device that manages a radio network. For example, the management device 10 is a device that manages communication of the terrestrial station 20. In a case where the core network is EPC, the management device 10 is, for example, a device having a function as a Mobility Management Entity (MME). In a case where the core network is 5GC, the management device 10 is, for example, a device having a function as an Access and Mobility Management Function (AMF) and/or a Session Management Function (SMF). Of course, the functions of the management device 10 are not limited to the MME, the AMF, and the SMF. For example, in a case where the core network is 5GC, the management device 10 may be a device having a function as a Network Slice Selection Function (NSSF), an Authentication Server Function (AUSF), or a Unified Data Management (UDM). Furthermore, the management device 10 may be a device having a function as a Home Subscriber Server (HSS).

Note that the management device 10 may have a function of a gateway. For example, in a case where the core network is EPC, the management device 10 may have a function as a Serving Gateway (S-GW) or a Packet Data Network Gateway (P-GW). Further, in a case where the core network is 5GC, the management device 10 may have a function as a User Plane Function (UPF). Note that the management device 10 is not necessarily a device constituting a core network. For example, it is assumed that the core network is a core network for Wideband Code Division Multiple Access (W-CDMA) or Code Division Multiple Access 2000 (cdma2000). At this time, the management device 10 may be a device that functions as a Radio Network Controller (RNC).

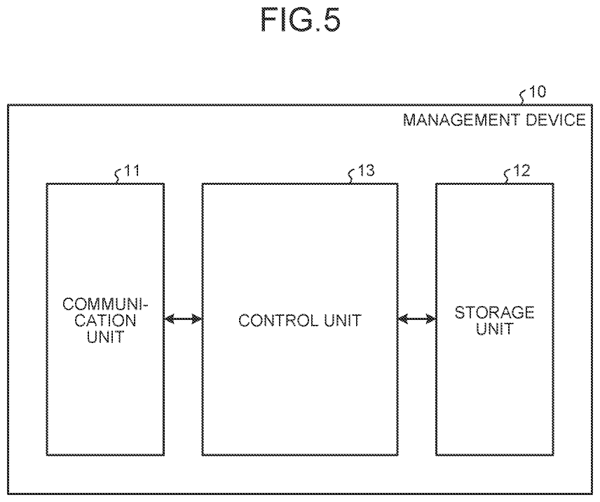

FIG. 5 is a diagram illustrating a configuration example of the management device 10 according to the embodiment of the present disclosure. The management device 10 includes a communication unit 11, a storage unit 12, and a control unit 13. Note that the configuration illustrated in FIG. 5 is a functional configuration, and the hardware configuration may be different from the functional configuration. Furthermore, the functions of the management device 10 may be implemented in a distributed manner in a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a Local Area Network (LAN) interface such as a Network Interface Card (NIC), or may be a Universal Serial Bus (USB) interface including a USB host controller, a USB port, or the like. Furthermore, the communication unit 11 may be a wired interface or a wireless interface. The communication unit 11 functions as a communication unit of the management device 10. The communication unit 11 communicates with the terrestrial station 20 and the like under the control of the control unit 13.

The storage unit 12 is a data readable/writable storage device such as a Dynamic Random Access Memory (DRAM), a Static Random Access Memory (SRAM), a flash memory, and a hard disk. The storage unit 12 functions as a storage means of the management device 10. The storage unit 12 stores, for example, a connection state of the terminal device 40. For example, the storage unit 12 stores an RRC state and an ECM state of the terminal device 40. The storage unit 12 may function as a home memory that stores the positional information of the terminal device 40.

The control unit 13 is a controller that controls each of the units of the management device 10. The control unit 13 is achieved by, for example, a processor such as a Central Processing Unit (CPU) and a Micro Processing Unit (MPU). For example, the control unit 13 is achieved by the processor executing various programs stored in the storage unit inside the management device 10 using the Random Access Memory (RAM) or the like as a working area. Note that the control unit 13 may be achieved by an integrated circuit such as an Application Specific Integrated Circuit (ASIC) and a Field Programmable Gate Array (FPGA). Any of the CPU, the MPU, the ASIC, and the FPGA can be regarded as a controller.

### <2.3. Configuration of Terrestrial Station>

Next, a configuration of the terrestrial station 20 will be described.

The terrestrial station 20 is a radio communication device that performs radio communication with the terminal device 40 via the satellite station 30. Note that the terrestrial station 20 may be configured to communicate with the terminal device 40 without interposing the satellite station 30.

The terrestrial station 20 is a type of communication device. More specifically, the terrestrial station 20 is a device corresponding to a radio base station (Base Station, Node B, eNB, gNB, or the like) or a radio access point. The terrestrial station 20 may be a radio relay station. Furthermore, the terrestrial station 20 may be an optical extension device called a Remote Radio Head (RRH). Furthermore, the terrestrial station 20 may be a receiving station such as a Field Pickup Unit (FPU). Furthermore, the terrestrial station 20 may be an Integrated Access and Backhaul (IAB) donor node or an IAB relay node that provides a radio access line and a radio backhaul line by means of time division multiplexing, frequency division multiplexing, or space division multiplexing.

Note that the radio access technology used by the terrestrial station 20 may be a cellular communication technology or a wireless LAN technology. Of course, the radio access technology used by the terrestrial station 20 is not limited thereto, and may be another radio access technology. For example, the radio access technology used by the terrestrial station 20 may be an LPWA communication technology. Of course, the radio communication used by the terrestrial station 20 may be radio communication using millimeter waves. Furthermore, the radio communication used by the terrestrial station 20 may be radio communication using radio waves or radio communication using infrared rays or visible light (optical radio communication).

The terrestrial station 20 may be able to perform Non-Orthogonal Multiple Access (NOMA) communication with the terminal device 40. Here, the NOMA communication is communication using a non-orthogonal resource (transmission, reception, or both). Note that the terrestrial station 20 may be able to perform the NOMA communication with another terrestrial station 20.

Note that the terrestrial stations 20 may be able to communicate with each other via an interface between a base station and a core network (for example, S1 Interface). This interface may be either wired or wireless. Furthermore, the base stations may be able to communicate with each other via an interface between base stations (for example, X2 Interface and S1 Interface). This interface may be either wired or wireless.

Note that the concept of the base station (also referred to as a base station) includes not only a donor base station but also a relay base station (also referred to as a relay station or a relay station). In addition, the concept of the base station includes not only a structure having a function of a base station but also a device installed in a structure.

The structure is, for example, a building such as a high-rise building, a house, a steel tower, a station facility, an airport facility, a harbor facility, and a stadium. Note that the concept of the structure includes not only the building but also a construction (non-building structure) such as a tunnel, a bridge, a dam, a wall, and an iron pillar, and equipment such as a crane, a gate, and a windmill. In addition, the concept of the structure includes not only a structure on land (on the ground in a narrow sense) or in the ground, but also a structure on water such as a pier and a megafloat, and a structure in water such as a marine observation facility. The base station may be rephrased as an information processing device.

The terrestrial station 20 may be a donor station or a relay station (relay station). Furthermore, the terrestrial station 20 may be a fixed station or a mobile station. The mobile station is a radio communication device (for example, a base station) configured to be movable. At this time, the terrestrial station 20 may be a device installed in a moving body or may be the moving body itself. For example, a relay station having mobility can be regarded as the terrestrial station 20 as a mobile station. In addition, a device that originally has mobility, such as a vehicle, a drone, and a smartphone, and is equipped with a function of a base station (at least a part of the function of the base station) is also regarded as the terrestrial station 20 as a mobile station.

Here, the moving body may be a mobile terminal such as a smartphone and a mobile phone. In addition, the moving body may be a moving body (for example, a vehicle such as an automobile, a bicycle, a bus, a truck, a motorcycle, a train, and a linear motor car) that moves on land (on the ground in a narrow sense) or a moving body (for example, a subway) that moves in the ground (for example, in a tunnel).

In addition, the moving body may be a moving body (for example, a ship such as a passenger ship, a cargo ship, and a hovercraft) that moves on water or a moving body (for example, a submersible ship such as a submersible vessel, a submarine, and an unmanned submersible instrument) that moves in water.

Note that the moving body may be a moving body (for example, an aircraft such as an airplane, an airship, and a drone) that moves in the atmosphere.

Furthermore, the terrestrial station 20 may be a terrestrial base station (terrestrial station) installed on the ground. For example, the terrestrial station 20 may be a base station arranged in a structure on the ground, or may be a base station installed in a moving body moving on the ground. More specifically, the terrestrial station 20 may be an antenna installed in a structure such as a building and a signal processing device connected to the antenna. Of course, the terrestrial station 20 may be a structure or a moving body itself. The “terrestrial” means ground in a broad sense including not only on land (on the ground in a narrow sense) but also in the ground, on water, and in water. Note that the terrestrial station 20 is not limited to a terrestrial base station. For example, the terrestrial station 20 may be an aircraft station. From the viewpoint of the satellite station 30, an aircraft station located around the earth can also be regarded as a terrestrial station.

The aircraft station is a radio communication device capable of floating in the atmosphere, such as an aircraft. The aircraft station may be a device mounted on an aircraft or the like, or may be the aircraft itself. Note that the concept of the aircraft includes not only a heavy aircraft such as an airplane and a glider but also a light aircraft such as a balloon and an airship. In addition, the concept of the aircraft includes not only the heavy aircraft and the light aircraft but also a rotorcraft such as a helicopter and an autogyro. Note that the aircraft station (or an aircraft on which the aircraft station is mounted) may be an unmanned aircraft such as a drone.

Note that the concept of the unmanned aircraft includes an Unmanned Aircraft System (UAS) and a tethered UAS. The concept of the unmanned aircraft also includes a Lighter than Air UAS (LTA) and a Heavier than Air UAS (HTA). The concept of the unmanned aircraft further includes a High Altitude UAS Platform (HAP).

The coverage of the terrestrial station 20 may be large such as a macro cell or small such as a pico cell. Of course, the coverage of the terrestrial station 20 may be extremely small, such as a femtocell. In addition, the terrestrial station 20 may have a beamforming capability. In this case, the terrestrial station 20 may form a cell or a service area for each beam.

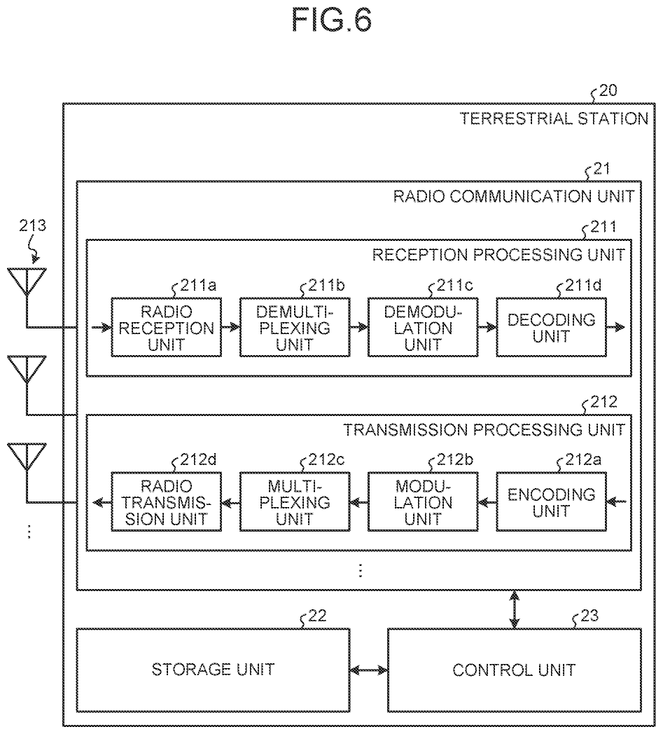

FIG. 6 is a diagram illustrating a configuration example of the terrestrial station 20 according to the embodiment of the present disclosure. The terrestrial station 20 includes a radio communication unit 21, a storage unit 22, and a control unit 23. Note that the configuration illustrated in FIG. 6 is a functional configuration, and the hardware configuration may be different from the functional configuration. Furthermore, the functions of the terrestrial station 20 may be implemented in a distributed manner in a plurality of physically separated configurations.

The radio communication unit 21 is a signal processing unit for performing radio communication with other radio communication devices (for example, the terminal device 40). The radio communication unit 21 operates under the control of the control unit 23. The radio communication unit 21 support one or a plurality of radio access schemes. For example, the radio communication unit 21 supports both NR and LTE. The radio communication unit 21 may support W-CDMA and cdma2000 as well as NR and LTE. Furthermore, the radio communication unit 21 may support an automatic retransmission technology such as Hybrid Automatic Repeat reQuest (HARQ).

The radio communication unit 21 includes a reception processing unit 211, a transmission processing unit 212, and an antenna 213. The radio communication unit 21 may include a plurality of reception processing units 211, a plurality of transmission processing units 212, and a plurality of antennas 213. Note that, in a case where the radio communication unit 21 supports a plurality of radio access schemes, each unit of the radio communication unit 21 can be configured individually for each radio access scheme. For example, each of the reception processing unit 211 and the transmission processing unit 212 may be configured individually for each of LTE and NR. Furthermore, the antenna 213 may include a plurality of antenna elements (for example, a plurality of patch antennas). In this case, the radio communication unit 21 may be configured to enable beamforming. The radio communication unit 21 may be configured to enable polarization beamforming using a vertically polarized wave (V-polarized wave) and a horizontally polarized wave (H-polarized wave).

The reception processing unit 211 processes an uplink signal received via the antenna 213. The reception processing unit 211 performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal. The reception processing unit 211 demultiplexes an uplink channel such as a Physical Uplink Shared Channel (PUSCH) and a Physical Uplink Control Channel (PUCCH) and an uplink reference signal from the signal subjected to these pieces of processing. The reception processing unit 211 demodulates the received signal using a modulation scheme such as Binary Phase Shift Keying (BPSK) and Quadrature Phase Shift Keying (QPSK) on the modulation symbol of the uplink channel. The modulation scheme used for demodulation may be 16 Quadrature Amplitude Modulation (QAM), 64 QAM, or 256 QAM. In this case, the signal points on the constellation do not necessarily have to be equidistant. The constellation may be a Non Uniform Constellation (NUC). The reception processing unit 211 performs decoding processing on the demodulated encoded bits of the uplink channel. The decoded uplink data and uplink control information are output to the control unit 23.

The transmission processing unit 212 performs transmission processing of downlink control information and downlink data. The transmission processing unit 212 encodes the downlink control information and the downlink data input from the control unit 23 using an encoding method such as block encoding, convolutional encoding, and turbo encoding. The transmission processing unit 212 modulates the encoded bits by means of a predetermined modulation scheme such as BPSK, QPSK, 16 QAM, 64 QAM, and 256 QAM. In this case, the signal points on the constellation do not necessarily have to be equidistant. The constellation may be a Non Uniform Constellation. The transmission processing unit 212 multiplexes the modulation symbol of each channel and the downlink reference signal and arranges the multiplexed symbol in a predetermined resource element. Then, the transmission processing unit 212 performs various types of signal processing on the multiplexed signal. For example, the transmission processing unit 212 performs processing such as conversion into a time domain by fast Fourier transform, addition of a guard interval (cyclic prefix), generation of a baseband digital signal, conversion into an analog signal, quadrature modulation, up-conversion, removal of an extra frequency component, and power amplification. The signal generated in the transmission processing unit 212 is transmitted from the antenna 213.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the radio communication unit 21 may be configured to enable beamforming. For example, the radio communication unit 21 may be configured to generate a directional beam by controlling the directivity of a radio signal using the plurality of antenna elements. Note that the antenna 213 may be a dual-polarized antenna. When the antenna 213 is a dual-polarized antenna, the radio communication unit 21 may use a vertically polarized wave (V-polarized wave) and a horizontally polarized wave (H-polarized wave) in transmitting a radio signal. Then, the radio communication unit 21 may control the directivity of the radio signal transmitted using the vertically polarized wave and the horizontally polarized wave.

The storage unit 22 is a storage device capable of reading and writing data, such as a DRAM, an SRAM, a flash memory, and a hard disk. The storage unit 22 functions as a storage unit of the terrestrial station 20.

The control unit 23 is a controller that controls each of the units of the terrestrial station 20. The control unit 23 is achieved by, for example, a processor such as a Central Processing Unit (CPU) and a Micro Processing Unit (MPU). For example, the control unit 23 is achieved by the processor executing various programs stored in a storage device inside the terrestrial station 20 using a Random Access Memory (RAM) or the like as a working area. Note that the control unit 23 may be achieved by an integrated circuit such as an Application Specific Integrated Circuit (ASIC) and a Field Programmable Gate Array (FPGA). Any of the CPU, the MPU, the ASIC, and the FPGA can be regarded as a controller.

### <2.4. Configuration of Satellite Station>

Next, a configuration of the satellite station 30 will be described.

The satellite station 30 is a relay station that relays communication between the terrestrial station 20 and the terminal device 40. Note that the satellite station 30 may be a base station that provides the terminal device 40 with the function of a base station.

The satellite station 30 is a radio communication device capable of floating outside the atmosphere. The satellite station 30 may be a device mounted on a space moving body such as an artificial satellite, or may be the space moving body itself. The space moving body is a moving body that moves outside the atmosphere. Examples of the space moving body include artificial bodies such as an artificial satellite, a spacecraft, a space station, and a probe.

Note that the satellite serving as the satellite station 30 may be any of a Low Earth Orbiting (LEO) satellite, a Medium Earth Orbiting (MEO) satellite, a Geostationary Earth Orbiting (GEO) satellite, and a Highly Elliptical Orbiting (HEO) satellite. Of course, the satellite station may be a device mounted on the low earth orbiting satellite, the medium earth orbiting satellite, the geostationary satellite, or the high elliptical orbiting satellite.

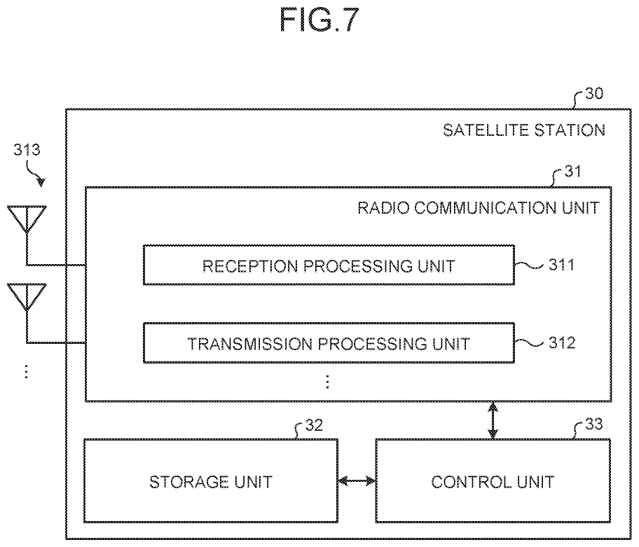

FIG. 7 is a diagram illustrating a configuration example of the satellite station 30 according to the embodiment of the present disclosure. The satellite station 30 includes a radio communication unit 31, a storage unit 32, and a control unit 33. Note that the configuration illustrated in FIG. 7 is a functional configuration, and the hardware configuration may be different from the functional configuration. Furthermore, the functions of the satellite station 30 may be implemented in a distributed manner in a plurality of physically separated configurations.

The radio communication unit 31 is a radio communication interface that performs radio communication with other radio communication devices (for example, the terrestrial station 20, the terminal device 40, the satellite station 50, and another satellite station 30). The radio communication unit 31 supports one or a plurality of radio access schemes. For example, the radio communication unit 31 supports both NR and LTE. The radio communication unit 31 may support W-CDMA and cdma3000 as well as NR and LTE. The radio communication unit 31 includes a reception processing unit 311, a transmission processing unit 312, and an antenna 313. The radio communication unit 31 may include a plurality of reception processing units 311, a plurality of transmission processing units 312, and a plurality of antennas 313. Note that, in a case where the radio communication unit 31 supports a plurality of radio access schemes, each unit of the radio communication unit 31 can be configured individually for each radio access scheme. For example, each of the reception processing unit 311 and the transmission processing unit 312 may be configured individually for each of LTE and NR. The configurations of the reception processing unit 311, the transmission processing unit 312, and the antenna 313 are similar to the configurations of the reception processing unit 311, the transmission processing unit 312, and the antenna 313 described above. Note that the radio communication unit 31 may be configured to enable beamforming similarly to the radio communication unit 21.

The storage unit 32 is a storage device capable of reading and writing data, such as a DRAM, an SRAM, a flash memory, and a hard disk. The storage unit 32 functions as a storage unit of the satellite station 30.

The control unit 33 is a controller that controls each unit of the satellite station 30. The control unit 33 is achieved by, for example, a processor such as a CPU and an MPU. For example, the control unit 33 is achieved by the processor executing various programs stored in a storage device inside the satellite station 30 using a RAM or the like as a working area. Note that the control unit 33 may be achieved by an integrated circuit such as an ASIC and an FPGA. Any of the CPU, the MPU, the ASIC, and the FPGA can be regarded as a controller.

### <2.5. Configuration of Terminal Device>

Next, a configuration of the terminal device 40 will be described.

The terminal device 40 is a radio communication device that performs radio communication with other communication devices such as the terrestrial station 20, the satellite stations 30 and 50, the base station 60, and the aircraft station 70. The terminal device 40 is, for example, a mobile phone, a smart device (a smartphone or a tablet), a personal digital assistant (PDA), or a personal computer. Furthermore, the terminal device 40 may be a device such as a business camera provided with a communication function, or may be a motorcycle, a moving relay vehicle, or the like on which a communication device such as a Field Pickup Unit (FPU) is mounted. Furthermore, the terminal device 40 may be a Machine to Machine (M2M) device or an Internet of Things (IoT) device.

Note that the terminal device 40 may be able to perform NOMA communication with the terrestrial station 20. Furthermore, the terminal device 40 may be able to use an automatic retransmission technology such as HARQ when communicating with the terrestrial station 20. The terminal device 40 may be able to perform sidelink communication with another terminal device 40. The terminal device 40 may be able to use the automatic retransmission technology such as HARQ even when performing the sidelink communication. Note that the terminal device 40 may also be able to perform the NOMA communication when performing communication (sidelink) with another terminal device 40. Furthermore, the terminal device 40 may be able to perform LPWA communication with another communication device (for example, the terrestrial station 20 and another terminal device 40). Furthermore, the radio communication used by the terminal device 40 may be radio communication using millimeter waves. Note that the radio communication (including sidelink communication) used by the terminal device 40 may be radio communication using radio waves or radio communication using infrared rays or visible light (optical radio communication).

Furthermore, the terminal device 40 may be a moving device. The moving device is a mobile radio communication device. At this time, the terminal device 40 may be a radio communication device installed in a moving body or may be the moving body itself. For example, the terminal device 40 may be a vehicle that moves on a road such as an automobile, a bus, a truck, and a motorcycle, or a radio communication device mounted on the vehicle. Note that the moving body may be a mobile terminal, or may be a moving body that moves on land (on the ground in a narrow sense), in the ground, on water, or in water. Furthermore, the moving body may be a moving body that moves inside the atmosphere, such as a drone and a helicopter, or may be a moving body that moves outside the atmosphere, such as an artificial satellite.

The terminal device 40 may be simultaneously connected to a plurality of base stations or a plurality of cells to perform communication. For example, in a case where one base station supports a communication area via a plurality of cells (for example, pCell or sCell), the base station can allow the terrestrial station 20 and the terminal device 40 to communicate with each other by bundling the plurality of cells by means of a Carrier Aggregation (CA) technology, a Dual Connectivity (DC) technology, or a Multi-Connectivity (MC) technology. Alternatively, by means of a Coordinated Multi-Point Transmission and Reception (COMP) technology via cells of different terrestrial stations 20, the terminal device 40 and the plurality of terrestrial stations 20 can communicate with each other.

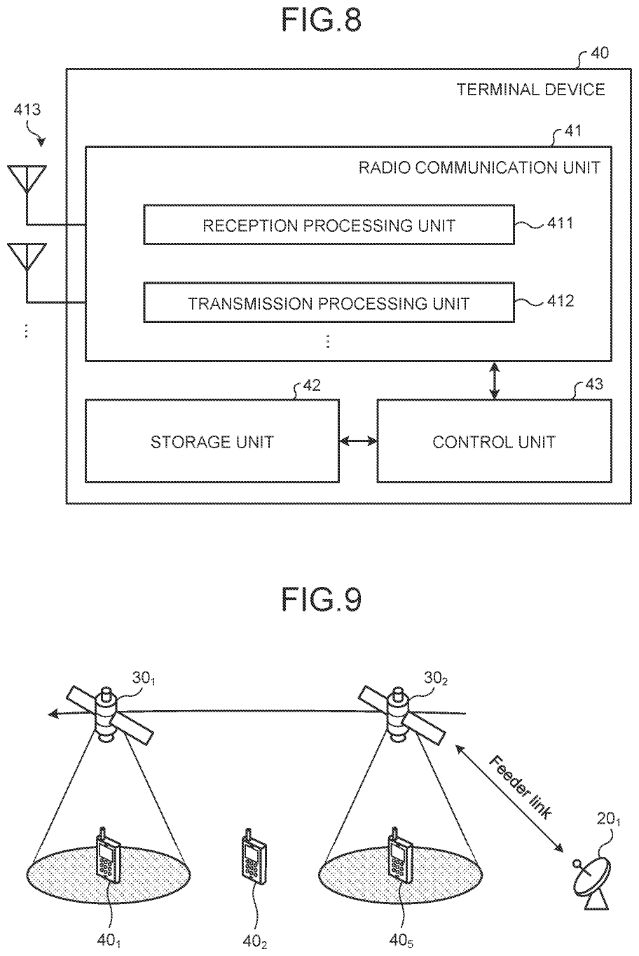

FIG. 8 is a diagram illustrating a configuration example of the terminal device 40 according to the embodiment of the present disclosure. The terminal device 40 includes a radio communication unit 41, a storage unit 42, and a control unit 43. Note that the configuration illustrated in FIG. 8 is a functional configuration, and the hardware configuration may be different from the functional configuration. Furthermore, the functions of the terminal device 40 may be implemented in a distributed manner in a plurality of physically separated configurations.

The radio communication unit 41 is a signal processing unit for performing radio communication with other radio communication devices (for example, the terrestrial station 20 and another terminal device 40). The radio communication unit 41 operates under the control of the control unit 43. The radio communication unit 41 includes a reception processing unit 411, a transmission processing unit 412, and an antenna 413. The configurations of the radio communication unit 41, the reception processing unit 411, the transmission processing unit 412, and the antenna 413 may be similar to those of the radio communication unit 21, the reception processing unit 211, the transmission processing unit 212, and the antenna 213 of the terrestrial station 20. Also, the radio communication unit 41 may be configured to enable beamforming similarly to the radio communication unit 21.

The storage unit 42 is a storage device capable of reading and writing data, such as a DRAM, an SRAM, a flash memory, and a hard disk. The storage unit 42 functions as a storage means of the terminal device 40.

The control unit 43 is a controller that controls each unit of the terminal device 40. The control unit 43 is achieved by, for example, a processor such as a CPU and an MPU. For example, the control unit 43 is achieved by the processor executing various programs stored in a storage device inside the terminal device 40 using a random access memory (RAM) or the like as a working area. Note that the control unit 43 may be achieved by an integrated circuit such as an ASIC and an FPGA. Any of the CPU, the MPU, the ASIC, and the FPGA can be regarded as a controller.

### 3. REGARDING SMALL MOBILE SATELLITE

The configuration of the communication system 1 has been described above. Next, problems in a case where the satellite station 30 is a small mobile satellite will be described. In the present embodiment, as the mobile satellite communication, for example, communication using a small satellite called Cube-sat, micro-satellite, or the like is considered.

The small satellite station 30 is inferior to conventional satellites in terms of power and antenna gain. Therefore, the cell size of the small satellite station 30 can be smaller than that of the conventional satellite. In addition, satellite communication using the small satellite may require repeated transmission more frequently than conventional satellite communication. Furthermore, in a case where communication with the terrestrial station 20 is performed, intermittent connection via a feeder link between the satellite station 30 and the terrestrial station 20 may be a problem.

Here, an example of satellite communication using the small satellite station 30 will be described with reference to FIG. 9. FIG. 9 is a diagram for describing an example of satellite communication according to the embodiment of the present disclosure.

The satellite stations 30₁ and 30₂ illustrated in FIG. 9 are, for example, small low earth orbiting satellites at an altitude of 600 km. The satellite station 30₂ is connected to the terrestrial station 20₁ via the feeder link, but the satellite station 30₁ is not connected to the terrestrial station 20₁ via the feeder link (no feeder link connection). Therefore, the terminal device 405 located within the coverage of the satellite station 30₂ can communicate with the terrestrial station 20₁ via the satellite station 30₂. On the other hand, the terminal device 40₁ located within the coverage of the satellite station 30₁ may not be able to communicate with the terrestrial station 20₁.

In addition, the cell size of the satellite station 30, which is a small low earth orbiting satellite, is, for example, 50 km, which is smaller than the cell size of a normal satellite station. Therefore, the cells of the plurality of satellite stations 30 do not overlap and are formed independently of each other. As a result, the plurality of satellite stations 30 cannot always provide communication services, and the terminal device 40₂ located outside the coverage (cell) of the satellite station 30 cannot perform communication.

Furthermore, in a case where the cell size of the satellite station 30, which is a small low earth orbiting satellite having an altitude of 600 km, is 50 km, the terminal device 40 that has entered the cell of the satellite station 30 goes out of the cell after about 6.5 seconds. In this manner, the satellite station 30, which is a small low earth orbiting satellite, and the terminal device 40 cannot communicate in a short time.

Furthermore, communication with an IoT sensor device is considered as one of use cases of satellite communication according to the embodiment of the present disclosure. It is expected that a large number of IoT sensor devices are arranged in a small range.

Therefore, there is a possibility that the IoT sensor devices that have become communicable by entering the cell of the satellite station 30 simultaneously start initial access. As a result, it is conceivable that delay until each IoT sensor device is connected to the satellite station 30 is longer due to occurrence of collision of transmission resources at the time of initial connection.

In such satellite communication, applying a handover technology is effective from the viewpoint of performing smooth inter-cell movement of the terminal device 40.

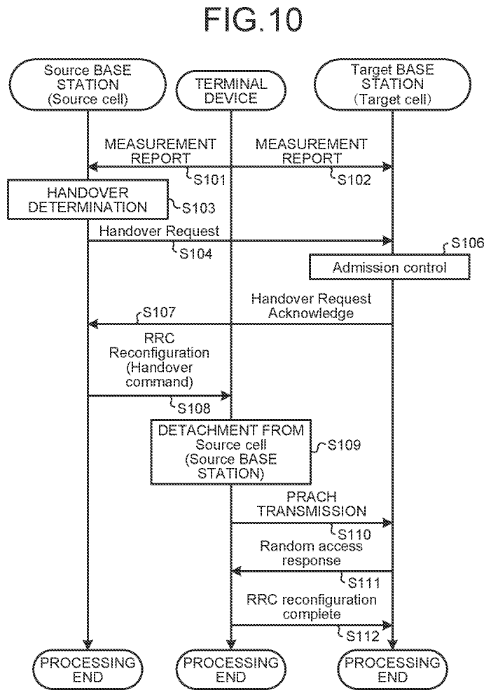

Here, a conventional handover will be described with reference to FIG. 10. FIG. 10 is a sequence diagram for describing an example of a flow of the handover. FIG. 10 illustrates a case where the terminal device 40 performs the handover from a source cell of a source base station as the handover source to a target cell of a target base station as the handover target.

As illustrated in FIG. 10, the terminal device 40 performs measurement and transmits a measurement report to the source base station (Step S101). Similarly, the terminal device 40 performs measurement and transmits a measurement report to the target base station (Step S102).

The source base station determines whether or not the handover of the terminal device 40 is necessary on the basis of the measurement report (Step S103). In a case of determining that the handover is necessary, the source base station requests the target base station to perform the handover (Step S104).

When receiving the handover request, the target base station performs admission control (Step S106) and notifies the source base station of Acknowledge for the handover request (Step S107).

Subsequently, the source base station transmits RRC Reconfiguration including a handover command to the terminal device 40 (Step S108), and notifies the terminal device of execution of the handover.

Upon receiving the RRC Reconfiguration, the terminal device 40 detaches from the source cell of the source base station (Step S109), and performs an initial access procedure on the target base station. For example, the terminal device 40 transmits a physical random access channel (PRACH) to the target base station (Step S110). The target base station transmits a random access response to the terminal device 40 (Step S111). When the terminal device 40 transmits RRC reconfiguration complete to the target base station (Step S112), the initial access procedure is completed and the handover processing is completed.

Note that, as the initial access procedure, the terminal device 40 may perform a two-step random access procedure (2-step RACH) or may perform a four-step random access procedure (4-step RACH).

In this manner, in the conventional handover, the terminal device 40 starts the handover at a time when the handover command is received from the source base station.

However, in the case of the satellite communication using the small satellite described above, the terminal device 40 cannot communicate with the target base station (refer to, for example, the satellite station 30₂ in FIG. 9) at the time when the handover command is received from the source base station (refer to, for example, the satellite station 30₁ in FIG. 9). Furthermore, when the terminal device 40 is in a state of being able to communicate with the target base station (refer to, for example, the satellite station 30₂ in FIG. 9), the terminal device cannot communicate with the source base station (refer to, for example, the satellite station 30₁ in FIG. 9) and cannot receive the handover command.

Therefore, it is difficult to apply, for example, the conventional handover sequence illustrated in FIG. 10 to the satellite communication using the small satellite described above.

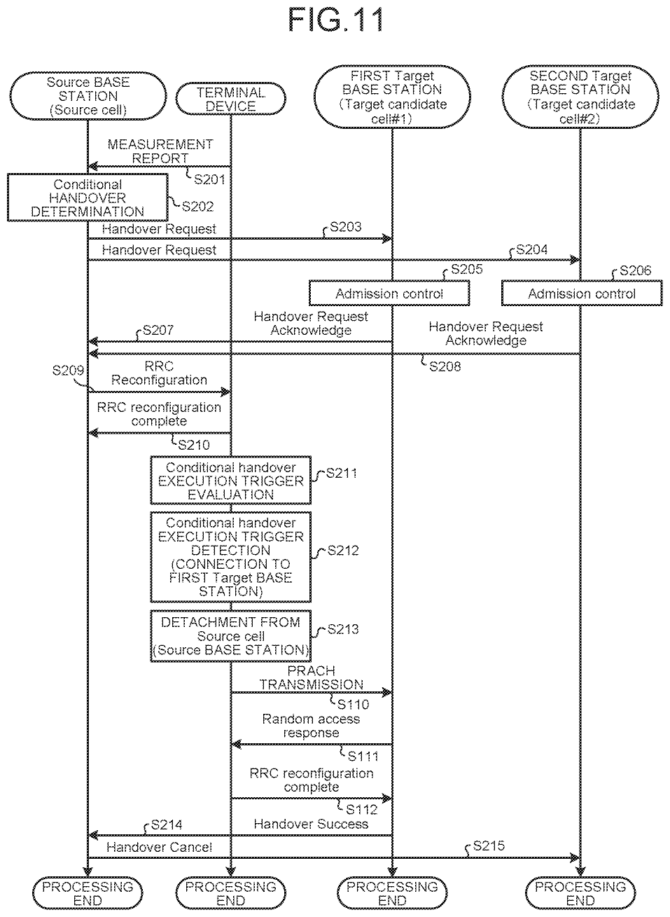

In addition, another example of the conventional handover is a Conditional handover, in which the source base station notifies the terminal device 40 of information about a handover target candidate in advance. FIG. 11 is a sequence diagram for describing another example of the flow of the handover. FIG. 11 illustrates a case where the terminal device 40 selects one of first and second target base stations that are handover target candidates and executes the handover. Note that the first target base station has a target candidate cell #1, and the second target base station has a target candidate cell #2.

As illustrated in FIG. 11, the terminal device 40 performs measurement and transmits a measurement report to the source base station (Step S201).

The source base station determines whether or not the Conditional handover of the terminal device 40 is necessary on the basis of the measurement report (Step S202). In a case of determining that the Conditional handover is necessary, the source base station requests the first target base station to perform the handover (Step S203) and requests the second target base station to perform the handover (Step S204).

When receiving the handover request, the first target base station performs admission control (Step S205). Similarly, when receiving the handover request, the second target base station performs admission control (Step S206). The first target base station notifies the source base station of Acknowledge for the handover request (Step S207). The second target base station notifies the source base station of Acknowledge for the handover request (Step S208).

Subsequently, the source base station transmits RRC Reconfiguration to the terminal device 40 (Step S209). The RRC Reconfiguration includes, for example, information regarding the first and second target base stations, which are handover target candidates and information regarding an execution trigger for executing the Conditional handover.

When receiving the RRC Reconfiguration, the terminal device 40 transmits RRC Reconfiguration complete to the source base station (Step S210), and performs an evaluation for the execution trigger for executing the Conditional handover (Step S211). When performing the evaluation for the execution trigger and detecting the execution trigger (Step S212), the terminal device 40 detaches from the source cell (source base station) (Step S213), and starts an initial connection procedure to the handover target base station. In FIG. 11, it is assumed that the first target base station is detected as the handover target base station.

As illustrated in FIG. 11, the terminal device 40 executes the initial connection procedure on the first target base station. Note that the initial connection procedure is the same as the procedure illustrated in FIG. 10.

The first target base station that has completed the initial connection procedure and connected to the terminal device 40 notifies the source base station of Handover Success indicating that the handover has succeeded (Step S214). The source base station that has received the Handover Success notifies the second target base station that has not been selected as the handover target of Handover Cancel (Step S215), thereby canceling the handover to the second target base station.

In this manner, in the conventional Conditional handover, the source base station does not determine the target base station as the handover target, but notifies the terminal device 40 of the target base station candidate. As a result, the terminal device 40 can select the target base station that can be connected at the time of performing the handover and perform the handover.

In addition, in the conventional Conditional handover, in order to achieve the seamless handover, for example, the terminal device detects the execution trigger of the Conditional handover in Step S212 of FIG. 11 and then detaches from the source base station in the subsequent Step S213. In other words, in order not to generate a period in which communication with all of the source base station and the target base station candidates becomes impossible and a period in which the initial connection becomes impossible, for example, the terminal device detects the execution trigger of the Conditional handover in Step S212 of FIG. 11 and then detaches from the source base station in the subsequent Step S213.

However, in the case of the satellite communication using the small satellite described above, the terminal device 40 cannot communicate with the source base station (refer to, for example, the satellite station 30₁ in FIG. 9) at the time of connecting to the target base station (refer to, for example, the satellite station 30₂ in FIG. 9).

Therefore, since the terminal device 40 detaches from the source base station in Step S213, the terminal device 40 maintains the connection with the source base station (refer to, for example, the satellite station 30₁ in FIG. 9) that cannot communicate.

Therefore, it is difficult to apply, for example, the conventional Conditional handover sequence illustrated in FIG. 11 to the satellite communication using the small satellite described above.

Under such circumstances, the embodiment of the present disclosure provides a more efficient handover method that solves these problems.

### 4. HANDOVER PROCEDURE

The problems of the handover of the small satellite station have been described above. Next, an operation of the communication system 1 that solves the problems will be described.

Note that the satellite station 30 in the following description can be replaced with a non-terrestrial base station device that operates as a communication device, such as a drone, a balloon, and an airplane. Furthermore, the present technology can not only be applied to this but can also be applied to communication between a terrestrial base station device and the terminal device 40.

Furthermore, in the following description, the satellite station 30 may be referred to simply as a base station (a source base station, a target base station, or the like).

The terminal device 40 according to the embodiment of the present disclosure is characterized in that the target cell is not determined after the terminal device 40 is detached from a source cell (source base station) at the time of a handover from the source cell to a target cell (target base station). Note that, although details will be described below, the time of the handover includes a period from a time immediately after a detachment procedure on the source cell (source base station) is performed or after the detachment procedure to a time before an evaluation for an execution trigger is performed.

Furthermore, the source cell is a cell formed by a mobile satellite (source base station) that is a handover source. The target cell is a cell formed by a mobile satellite (target base station) that is a handover target.

The aforementioned phrase, the target cell is not determined, means that the target cell to which the terminal device 40 attempts initial connection is not determined. That is, it means that the terminal device 40 is not in a state of being able to perform the initial connection on the target cell. Alternatively, it means that the terminal device 40 has not received a Synchronization signal of the target cell. Alternatively, the phrase, the target cell is not determined, may be replaced with a phrase, an execution trigger of the handover to the target cell is not generated. The phrase, the execution trigger of the handover to the target cell is not generated, may mean, for example, a state in which RSPR of the target cell is less than a predetermined value.

In this manner, the handover according to the embodiment of the present disclosure includes a period in which the terminal device 40 cannot communicate with both the source cell and the target cell and a period in which the initial connection cannot be performed.

Note that one or a plurality of target cells that are handover target candidates may be set in advance. That is, the terminal device 40 may select a target cell (target base station) with which the terminal device 40 is to perform the initial connection procedure from among one or more target cells (target base stations) set in advance as handover target candidates.

### <4.1. First Example of Handover>

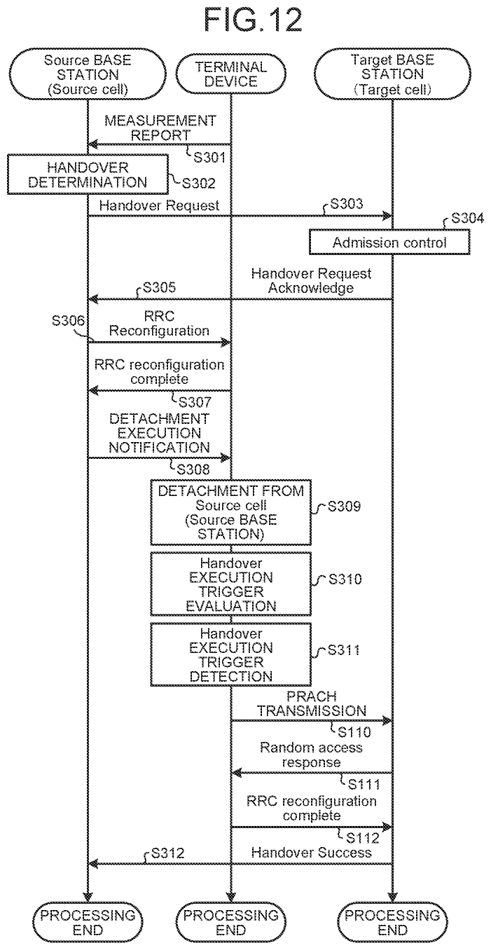

FIG. 12 is a sequence diagram illustrating an example of a flow of handover processing according to the embodiment of the present disclosure. FIG. 12 illustrates processing in a case where the terminal device 40 performs the handover from the source cell to the target cell.

As illustrated in FIG. 12, the terminal device 40 performs measurement and transmits a measurement report to the source base station (Step S301).

The source base station determines whether or not the handover of the terminal device 40 is necessary on the basis of the measurement report (Step S302). In a case of determining that the handover is necessary, the source base station requests the target base station to perform the handover (Step S303).

When receiving the handover request, the target base station performs admission control (Step S304), performs handover availability determination, and notifies the source base station of Acknowledge for the handover request (Step S305).

Subsequently, the source base station transmits RRC Reconfiguration to the terminal device 40 to notify the terminal device of information regarding the handover (Step S306). The terminal device 40 that has received the RRC Reconfiguration transmits RRC reconfiguration complete to the source base station (Step S307).

The information regarding the handover includes at least one of procedure information regarding a handover procedure on the target cell and execution trigger information regarding an execution trigger for executing the handover to the target cell. Note that details of the information regarding the handover will be described below.

Note that, if there is information other than the procedure information and the execution trigger information described above that may be necessary for the handover, the source base station may include the information in the information regarding the handover and transmit the information to the terminal device 40.

Furthermore, the source base station may notify the terminal device 40 of a part or all of the information regarding the handover as cell-specific information such as System information.

As illustrated in FIG. 12, the source base station that has received the RRC reconfiguration complete transmits a detachment execution notification instructing execution of the detachment procedure to the terminal device 40 (Step S308). The terminal device 40 performs the detachment procedure on the source base station according to the detachment execution notification, and detaches from the source cell (source base station) (Step S309).

Note that, for example, by including the detachment execution notification in the RRC reconfiguration, in other words, by causing the terminal device 40 to execute the detachment procedure with the reception of the RRC reconfiguration as a trigger, the source base station can omit the transmission of the detachment execution notification.

Here, in Step S309, the terminal device 40 performs the detachment procedure on the source base station, so that the terminal device 40 cannot communicate with the source base station. In addition, since the terminal device 40 has not performed an attaching procedure on the target base station, the terminal device 40 cannot communicate with the target base station either. In this manner, the terminal device 40 is in a state in which the target cell is not determined from a time immediately after executing the detachment procedure on the source base station to a time before detecting the execution trigger.

As illustrated in FIG. 12, the terminal device 40 detached from the source cell (source base station) performs an evaluation for the execution trigger of the handover (Step S310), and detects the execution trigger of the handover (Step S311).

For example, it is assumed that the fact that RSPR of the target base station is equal to or more than a predetermined value is an execution trigger of the handover. In this case, the terminal device 40 measures the RSPR of the target base station, and determines whether or not the measured RSPR is the predetermined value or more, thereby performing the evaluation for the execution trigger. The terminal device 40 detects the execution trigger by detecting that the RSPR is the predetermined value or more. The predetermined value may be notified or obtained from the source base station, or may be set in advance.

In addition, for example, it is assumed that expiry of a predetermined timer of the target base station is an execution trigger of the handover. In this case, the terminal device 40 starts measurement of the target cell after the predetermined timer expires. The predetermined timer may be notified or obtained from the source base station, or may be set in advance.

Furthermore, both of the above two example cases can include a period in which the terminal device 40 cannot communicate with both the source cell and the target cell and a period in which the initial connection cannot be performed.

The terminal device 40 that has detected the execution trigger executes an initial connection procedure on the target base station. The detection of the execution trigger may be rephrased as a trigger for the initial connection to the target cell.

The target base station that has completed the initial connection procedure and connected to the terminal device 40 notifies the source base station of Handover Success indicating that the handover has succeeded (Step S312). This notification may directly be notified from the target base station to the source base station, or may be notified via a terrestrial station.

In this manner, the terminal device 40 according to the embodiment of the present disclosure detects the handover execution trigger after being detached from the source base station and attaches to the target base station. As a result, the terminal device 40 can appropriately perform the handover even in the satellite communication using the small satellite.

Accordingly, the terminal device 40 can smoothly move from the source cell to the target cell, and more efficient communication can be performed in a short time.

### <4.2. Second Example of Handover>

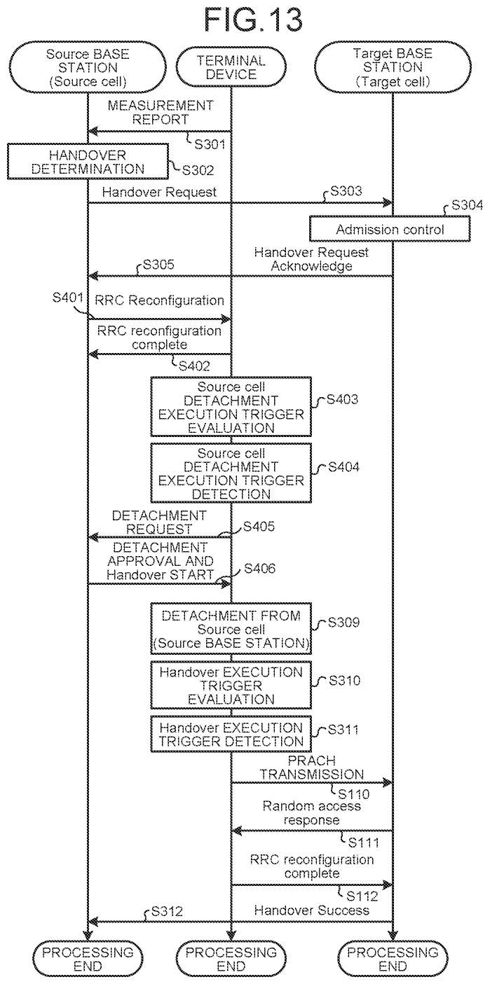

FIG. 13 is a sequence diagram illustrating another example of the flow of the handover processing according to the embodiment of the present disclosure. In FIG. 13, the terminal device 40 executes the detachment procedure by detecting a detachment execution trigger. Note that the same steps as those in FIG. 12 are denoted by the same step numbers, and description thereof is omitted.

The source base station that has received the Handover Request Acknowledge in Step S305 performs RRC reconfiguration (Step S401) and notifies the terminal device 40 of information regarding the handover. The terminal device 40 that has received the RRC reconfiguration transmits RRC reconfiguration complete to the source base station (Step S402).

In FIG. 13, the source base station notifies the terminal device 40 of at least one piece of the following information as the information regarding the handover.
Procedure information regarding handover procedure on target cell
Execution trigger information regarding execution trigger for executing handover on target cell
Detachment execution trigger information regarding detachment execution trigger for executing detachment procedure from source cell

Note that details of the information regarding the handover will be described below.

Note that, if there is information other than the procedure information, the execution trigger information, and the detachment execution trigger information described above that may be necessary for the handover, the source base station may include the information in the information regarding the handover and transmit the information to the terminal device 40.

Furthermore, the source base station may notify the terminal device 40 of a part or all of the information regarding the handover as cell-specific information such as System information.

As illustrated in FIG. 13, the terminal device 40 performs an evaluation for the detachment execution trigger for executing detachment from the source cell (Step S403), and detects the detachment execution trigger (Step S404).

For example, it is assumed that the fact that RSPR of the source base station is equal to or less than a predetermined value is a detachment execution trigger. In this case, the terminal device 40 measures the RSPR of the source base station, and determines whether or not the measured RSPR is the predetermined value or less, thereby performing the evaluation for the detachment execution trigger. The terminal device 40 detects the detachment execution trigger by detecting that the RSPR is equal to or less than the predetermined value.

The terminal device 40 that has detected the execution trigger may request the source base station to approve detachment (Step S405). When receiving detachment approval and an instruction to start the handover from the source base station (Step S406), the terminal device 40 performs a detachment procedure on the source base station and detaches from the source cell (Step S309). Note that processing after the detachment from the source cell is the same as the processing illustrated in FIG. 12, and thus description thereof is omitted.

As described above, the terminal device 40 according to the embodiment of the present disclosure detaches from the source cell in a case of detecting the detachment execution trigger for detaching from the source base station. In this case as well as the handover processing of FIG. 12, the terminal device 40 can appropriately perform the handover.

Accordingly, the terminal device 40 can smoothly move from the source cell to the target cell, and more efficient communication can be performed in a short time.

Note that, in FIG. 13, the terminal device 40 transmits the detachment request to the source base station and then executes the detachment procedure on the source base station, but the present invention is not limited thereto. For example, when detecting the detachment execution trigger, the terminal device 40 may execute the detachment procedure on the source base station. In this case, Steps S403 and S404 in FIG. 13 can be omitted.

### <4.3. First Example of Conditional Handover>

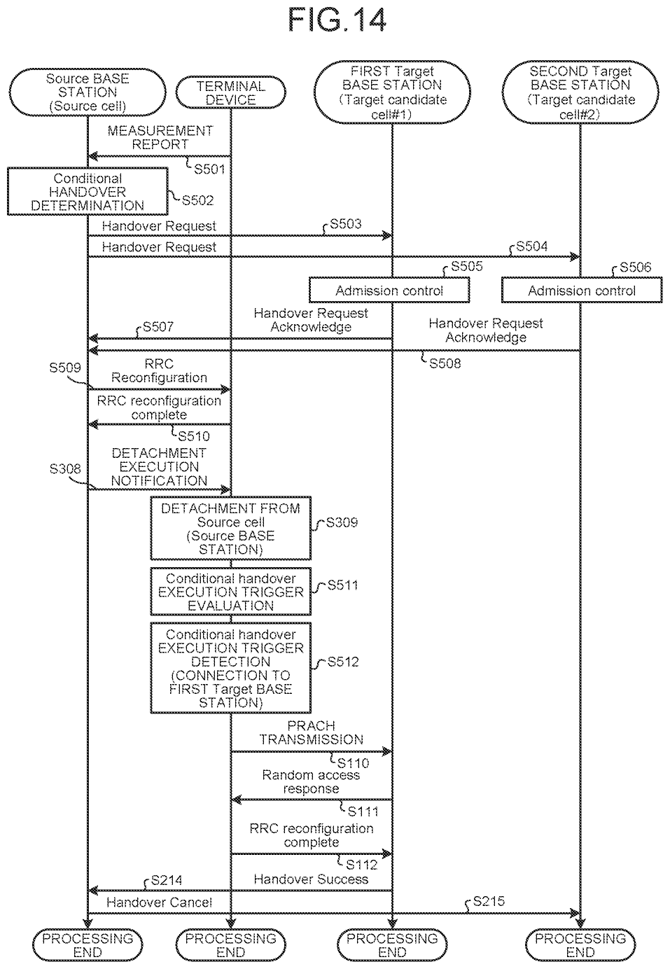

FIG. 14 is a sequence diagram illustrating an example of a flow of Conditional handover processing according to the embodiment of the present disclosure. FIG. 14 illustrates a case where the terminal device 40 selects a target base station to be connected from among one or more target base station candidates (for example, first and second target base stations) set in advance as handover target candidates and executes the handover.

As illustrated in FIG. 14, the terminal device 40 performs measurement and transmits a measurement report to the source base station (Step S501).

The source base station determines whether or not the Conditional handover of the terminal device 40 is necessary on the basis of the measurement report (Step S502). In a case of determining that the Conditional handover is necessary, the source base station requests the first target base station to perform the handover (Step S503) and requests the second target base station to perform the handover (Step S504).

When receiving the handover request, the first target base station performs admission control (Step S505). Similarly, when receiving the handover request, the second target base station performs admission control (Step S506). The first target base station notifies the source base station of Acknowledge for the handover request (Step S507). The second target base station notifies the source base station of Acknowledge for the handover request (Step S508).

Subsequently, the source base station performs RRC reconfiguration (Step S509) and notifies the terminal device 40 of information regarding the Conditional handover. The terminal device 40 that has received the RRC reconfiguration transmits RRC reconfiguration complete to the source base station (Step S510).

In FIG. 14, the source base station notifies the terminal device 40 of at least one piece of the following information as the information regarding the Conditional handover.
Procedure information regarding handover procedure on target cell
Execution trigger information regarding execution trigger for executing handover on target cell

Note that details of the information regarding the Conditional handover will be described below.

Note that, if there is information other than the procedure information and the execution trigger information described above that may be necessary for the Conditional handover, the source base station may include the information in the information regarding the Conditional handover and transmit the information to the terminal device 40.

Furthermore, the source base station may notify the terminal device 40 of a part or all of the information regarding the Conditional handover as cell-specific information such as System information.

Note that processing before detachment from the source cell is the same as that in FIG. 12, and thus description thereof is omitted.

The terminal device 40 detached from the source cell performs an evaluation for the execution trigger of the Conditional handover (Step S511), and detects an execution trigger of the Conditional handover (Step S512).

For example, it is assumed that the fact that RSPR of the target base station is equal to or more than a predetermined value is an execution trigger of the Conditional handover. In this case, the terminal device 40 measures the RSPRs of the first target base station and the second target base station that are the target base station candidates, and determines whether or not the measured RSPRs are a predetermined value or more, thereby performing the evaluation for the execution trigger. In a case where there is a target base station candidate whose RSPR is the predetermined value or more, this means that the terminal device 40 has detected an execution trigger of the handover to the target base station. In FIG. 14, it is assumed that the terminal device 40 has detected the execution trigger indicating that the first target base station is the handover target base station. The predetermined value may be notified or obtained from the source base station, or may be set in advance.

In addition, for example, it is assumed that expiry of a predetermined timer of the target base station is an execution trigger of the Conditional handover. In this case, the terminal device 40 starts measurement of the target cell candidate after the predetermined timer expires. The predetermined timer may be notified or obtained from the source base station, or may be set in advance.

Furthermore, both of the above two example cases can include a period in which the terminal device 40 cannot communicate with both the source cell and the target cell candidate and a period in which the initial connection cannot be performed.

The terminal device 40 that has detected the execution trigger executes an initial connection procedure on the target base station. Note that the detection of the execution trigger may be rephrased as a trigger for the initial connection to the target cell.

In this manner, the terminal device 40 according to the embodiment of the present disclosure selects a handover target base station from target base station candidates after being detached from the source cell. The terminal device 40 can appropriately perform the Conditional handover even in the satellite communication using the small satellite.

Accordingly, the terminal device 40 can smoothly move from the source cell to the target cell, and more efficient communication can be performed in a short time.

### <4.4. Second Example of Conditional Handover>

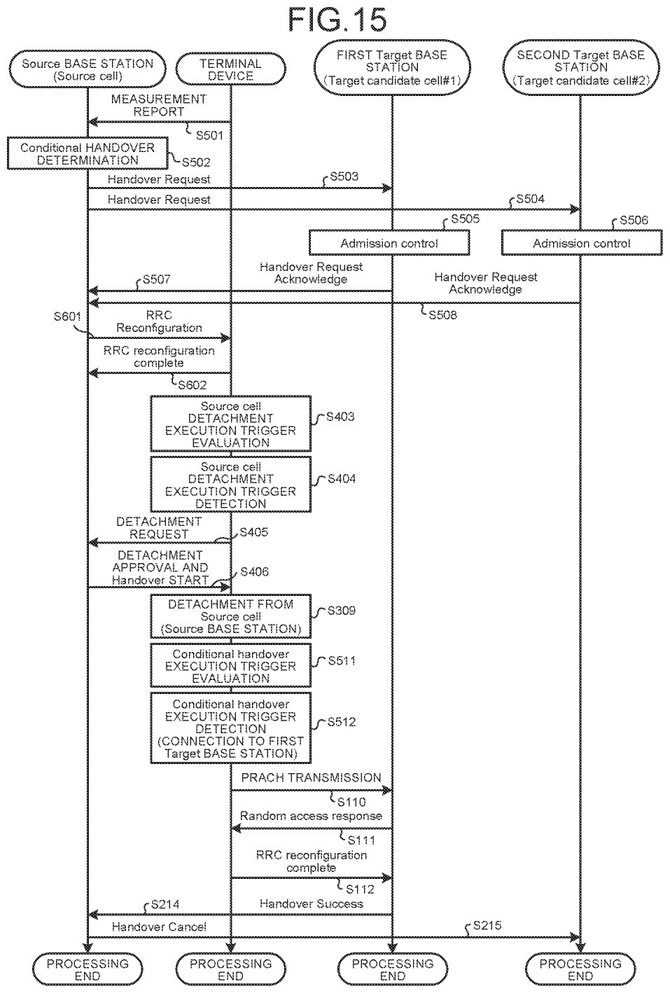

FIG. 15 is a sequence diagram illustrating another example of the flow of the Conditional handover processing according to the embodiment of the present disclosure. In FIG. 15, the terminal device 40 executes the detachment procedure by detecting a detachment execution trigger. Note that the same steps as those in FIG. 14 are denoted by the same step numbers, and description thereof is omitted.

As illustrated in FIG. 15, the source base station that has received the Handover Request Acknowledge in Steps S507 and S508 performs RRC reconfiguration (Step S601) and notifies the terminal device 40 of information regarding the handover. The terminal device 40 that has received the RRC reconfiguration transmits RRC reconfiguration complete to the source base station (Step S602).

In FIG. 15, the source base station notifies the terminal device 40 of at least one piece of the following information as the information regarding the Conditional handover.
Procedure information regarding handover procedure on target cell
Execution trigger information regarding execution trigger for executing handover on target cell
Detachment execution trigger information regarding detachment execution trigger for executing detachment procedure from source cell

Note that details of the information regarding the Conditional handover will be described below.

Note that, if there is information other than the procedure information, the execution trigger information, and the detachment execution trigger information described above that may be necessary for the Conditional handover, the source base station may include the information in the information regarding the Conditional handover and transmit the information to the terminal device 40.

Furthermore, the source base station may notify the terminal device 40 of a part or all of the information regarding the Conditional handover as cell-specific information such as System information.

Note that a flow of processing before detachment from the source cell is the same as that in FIG. 13, and thus description thereof is omitted. In addition, a flow of processing after detachment from the source cell is the same as that in FIG. 14, and thus description thereof is omitted.

As described above, the terminal device 40 according to the embodiment of the present disclosure detaches from the source cell in a case of detecting the detachment execution trigger for detaching from the source base station. In this case as well as the Conditional handover processing of FIG. 14, the terminal device 40 can appropriately perform the Conditional handover.

Accordingly, the terminal device 40 can smoothly move from the source cell to the target cell, and more efficient communication can be performed in a short time.

### 5. INFORMATION REGARDING HANDOVER

Next, an example of the aforementioned information regarding the handover (or the Conditional handover) will be described. The terminal device 40 receives from a source cell (source base station) the information regarding the handover procedure on one or a plurality of target cells (target base stations). In this manner, the number of the target cells serving as the handover targets may be one or a plurality. For example, in a case where there are a plurality of satellites that move on a plurality of orbits, the terminal device 40 is to connect to any one of target cells formed by the plurality of satellites.

### <5.1. Procedure Information>

First, an example of the procedure information regarding the handover procedure on the target cell will be described.

The procedure information includes, for example, at least one piece of the following information.
Information 1-1: Physical Random Access Channel (PRACH) transmission resource of target cell
Information 1-2: PRACH transmission Preamble sequence of target cell
Information 1-3: Cell ID of target cell
Information 1-4: Uplink/Downlink carrier frequency of target cell
Information 1-5: Bandwidth of target cell
Information 1-6: Terminal unique ID (C-RNTI: Cell-Radio Network Temporary Identifier) after handover
Information 1-7: Radio Resource Configuration after handover
Information 1-8: Conditions for updating information set regarding handover
Information 1-9: Trigger information for executing handover
Information 1-10: Timing advance information of target cell
Information 1-11: SSB index of target cell
Information 1-12: Information regarding transmission weight
Information 1-13: Information regarding skipping of Random access procedure
Information 1-14: information regarding 2-STEP initial access (or 4-STEP initial access)

The above-described procedure information is notified by the source base station by using, for example, System Information, RRC signaling, Medium Access Control Element (MAC CE), or Downlink Control Information (DCI).

Note that skipping of the Random access procedure in Information 1-13 will be described below.

### <5.2. Execution Trigger Information>

Next, an example of the execution trigger information regarding the execution trigger for executing the handover on the target cell will be described.

The execution trigger information includes, for example, at least one piece of the following information.
Information 2-1: Information regarding RSRP of target cell candidate
Information 2-2: Information regarding Reference Signal Received Quality (RSRQ) of target cell candidate
Information 2-3: Information regarding Received Signal Strength Indicator (RSSI) of target cell candidate
Information 2-4: Timer information regarding execution of handover on target cell candidate
Information 2-5: Information regarding start time of execution of handover on target cell candidate
Information 2-6: Information regarding start time of execution of trigger detection operation for execution of handover on target cell candidate
Information 2-7: Information regarding operation after expiry of timer regarding execution of handover on target cell candidate
Information 2-8: Operation in case of reception of synchronization signal of cell other than target cell candidate

For example, when acquiring the information indicated in Information 2-1, 2-2, and 2-3, the terminal device 40 performs the detachment procedure on the source base station, and then compares the execution trigger information with at least one of the RSRP of the target cell, the RSRQ of the target cell, and the RSSI of the target cell, and in a case where the value exceeds, this means that the terminal device 40 has detected the execution trigger.

For example, when acquiring the information regarding the start time of execution of the handover on the target cell candidate indicated in Information 2-5, the terminal device 40 determines whether or not the current time is at or after the start time of execution of the handover on the basis of the information to perform the evaluation for the execution trigger. In a case where the current time is at or after the start time, this means that the terminal device 40 has detected the execution trigger.

Furthermore, for example, when acquiring the information regarding the start time of execution of the trigger detection operation for execution of the handover indicated in Information 2-6, the terminal device 40 starts the evaluation for the execution trigger on the basis of the start time of execution. As a result, the terminal device 40 can avoid unnecessary execution trigger evaluation such as performing the evaluation for the execution trigger when the terminal device is outside the target cell, and power consumption can further be reduced. Here, the information regarding the start time of execution may be information indicating a time until the execution start such as a timer.

Note that the information regarding operation after expiry of a timer regarding execution of the handover on the target cell candidate in Information 2-7 and the operation in a case of reception of a synchronization signal of a cell other than the target cell candidate in Information 2-8 will be described below.

Furthermore, the above-described execution trigger information is notified by the source base station by using, for example, System Information, RRC signaling, MAC CE, or DCI.

### <5.3. Detachment Execution Trigger Information>

Next, an example of the detachment execution trigger information regarding the detachment execution trigger for executing the detachment procedure from the source cell will be described.

The detachment execution trigger information includes, for example, at least one piece of the following information.
Information 3-1: RSRP information of source cell
Information 3-2: RSRQ information of source cell
Information 3-3: RSSI information of source cell
Information 3-4: Information regarding timer for executing detachment from source cell
Information 3-5: Information regarding time of execution of detachment from source cell
Information 3-6: Information regarding execution of detachment from source cell

For example, when acquiring the information regarding a timer for executing detachment from the source cell indicated in Information 3-4, the terminal device 40 measures a period from the acquisition of the information, and determines whether or not the measured period is equal to or longer than a period indicated by the timer, to perform an evaluation for the detachment execution trigger. When the measured period is equal to or longer than the period indicated by the timer, this means that the detachment execution trigger has been detected, and the terminal device 40 detaches from the source cell.

For example, when acquiring the time of execution of detachment indicated in Information 3-5, the terminal device 40 determines whether or not the current time is at or after the time of execution of detachment on the basis of the information to perform an evaluation for the detachment execution trigger. When the measured time is at or after the time of execution of detachment, this means that the detachment execution trigger has been detected, and the terminal device 40 detaches from the source cell.

Furthermore, the above-described detachment execution trigger information is notified by the source base station by using, for example, System Information, RRC signaling, MAC CE, or DCI.

### <5.4. Switching Between Handover and Conditional Handover>

The source base station can notify the terminal device 40 of execution information indicating which handover is to be executed, the handover processing illustrated in FIG. 12 or 13 or the Conditional handover processing illustrated in FIG. 14 or 15.

When receiving the implementation information, the terminal device 40 executes a handover (either the handover processing or the Conditional handover) indicated in the execution information. When not receiving the execution information, the terminal device 40 executes a preset handover (either the handover processing or the Conditional handover).

The source base station includes the execution information in the above-described procedure information and transmits the information to the terminal device 40. Alternatively, the source base station may notify the terminal device 40 of the execution information in advance using System information or the like.

<5.5. Case of Reception of Synchronization Signal of Cell Other than Target Cell Candidate>

Here, the operation of the terminal device 40 in a case where the terminal device 40 receives a synchronization signal of a cell other than the target cell candidate before receiving the target cell candidate will be described. The terminal device 40 may perform any of the following operation examples on the basis of the information regarding the operation in a case of reception of a synchronization signal of a cell other than the target cell candidate (refer to Information 2-8) included in the aforementioned execution trigger information. Alternatively, any of the following operation examples determined in advance may be performed.
Operation Example 1-1: The terminal device 40 is not connected to a cell other than the target cell candidate.
Operation Example 1-2: In a case where the timer regarding handover execution is Active, the terminal device 40 is not connected to a cell other than the target cell candidate.
Operation Example 1-3: In a case where the timer regarding handover execution Expires, the terminal device 40 may be connected to a cell other than the target cell candidate. Alternatively, the operation is performed according to the information regarding an operation after expiry of the timer regarding execution of the handover on the target cell candidate, which is notified from the source base station.

### <5.6. Case of Expiry of Timer Regarding Execution of Handover on Target Cell Candidate>

Here, the operation of the terminal device 40 after expiry of the timer regarding execution of the handover on the target cell candidate will be described. The terminal device 40 may perform any of the following operation examples on the basis of the information regarding the operation after expiry of the timer regarding execution of the handover on the target cell candidate (refer to Information 2-7) included in the aforementioned execution trigger information. Alternatively, any of the following operation examples determined in advance may be performed.
Operation Example 2-1: The operation is performed according to the information regarding the operation after expiry of the timer regarding execution of the handover on the target cell candidate, which is provided from the source base station to the terminal device 40.
Operation Example 2-2: After the timer expires, the terminal device 40 stands by until a synchronization signal of a cell (the target cell candidate or a cell other than the target cell candidate) is detected.
Operation Example 2-3: In the case of expiry of the timer, the terminal device 40 discards the held information regarding the Conditional handover (or handover).

### <5.7. Case of Reception of Information Regarding Skipping of Random Access Procedure>

Here, the operation of the terminal device 40 in a case where information regarding skipping of the Random access procedure is received will be described. In this case, the terminal device 40 may omit the initial connection procedure to the target cell and immediately start the data transmission. For example, in a case of satellite communication, the terminal device 40 can estimate the distance to the target base station in advance. In this case, the terminal device 40 can omit the initial connection procedure and synchronize the uplink data communication. More specifically, the terminal device 40 can estimate the distance to the satellite which is the target base station using positional information, movement information, and orbit information of the satellite, positional information of the terminal device 40 by means of a global positioning system (GPS), time information, and the like, and transmit data in a state of achieving uplink synchronization.

### <5.8. Others>

The source base station may switch between providing contention free handover information or providing contention based handover information according to the priority of the terminal device 40, the priority of data, or the like. On the basis of the information from the source base station, the terminal device 40 switches between executing the contention free handover and executing the contention based handover according to at least one of the priority of the terminal device itself and the priority of the data that the terminal device itself transmits or receives.

For example, the source base station provides the contention free handover information to the important (high-priority) terminal device 40 or the terminal device 40 that transmits and receives important data. On the other hand, for example, the source base station provides (contention based) handover information that may cause a contention to the unimportant (low-priority) terminal device 40 or the terminal device 40 that transmits and receives unimportant data.

For example, the terminal device 40 may request the source base station to perform the contention free handover. The terminal device 40 can include a contention free handover execution request in, for example, Capability information of the terminal device 40 or the detachment request (refer to Step S405 in FIGS. 13 and 15) and notify the source base station of the request.

Alternatively, the terminal device 40 may provide the source base station with determination information for letting the source base station determine whether to provide the contention free handover information or the contention based handover information. The terminal device 40 can provide, as the determination information, for example, Capability information of the terminal device 40, attribute information of the terminal device 40, information regarding a type of data that the terminal device 40 transmits or receives, or the like to the source base station.

### 6. MODIFICATION EXAMPLES

The above-described embodiment is an example, and various changes and applications are possible.

For example, in the above-described embodiment, the terminal device 40 communicates with the terrestrial station 20 via the satellite station 30, but the terminal device 40 may communicate with the terrestrial station 20 via an aircraft station. In this case, the satellite station 30 appearing in the above-described embodiment may be replaced with an aircraft station. In addition, the satellite station 30 appearing in the above-described embodiment can be replaced with a non-terrestrial station (non-terrestrial base station).

Furthermore, the terminal device 40 may communicate with the terrestrial station 20 via a terrestrial station (terrestrial base station). In this case, the satellite station 30 appearing in the above-described embodiment may be replaced with a terrestrial station. The terrestrial station may include a terminal device. In addition, the satellite station 30 appearing in the above-described embodiment can be replaced with a base station, a terminal device, or a relay station.

For example, the control device that controls the management device 10, the terrestrial station 20, the satellite station 30, and the terminal device 40 of the present embodiment may be achieved by a dedicated computer system or a general-purpose computer system.

For example, a communication program for executing the above-described operation is stored and distributed in a computer-readable recording medium such as an optical disk, a semiconductor memory, a magnetic tape, and a flexible disk. Then, for example, the program is installed in a computer, and the above-described processing is executed to configure the control device. At this time, the control device may be a device (for example, a personal computer) outside the management device 10, the terrestrial station 20, the satellite station 30, and the terminal device 40. Furthermore, the control device may be a device (for example, the control unit 13, the control unit 23, the control unit 33, and the control unit 43) inside the management device 10, the terrestrial station 20, the satellite station 30, and the terminal device 40.

Also, the above communication program may be stored in a disk device included in a server device on a network such as the Internet so that the communication program can be downloaded to a computer. Also, the above-described function may be fulfilled by cooperation of an operating system (OS) and application software. In this case, a portion other than the OS may be stored in a medium and distributed, or the portion other than the OS may be stored in a server device and downloaded to a computer.

Also, among the pieces of processing described in the above embodiment, all or a part of the pieces of processing described as being performed automatically can be performed manually, or all or a part of the pieces of processing described as being performed manually can be performed automatically by a known method. In addition, the processing procedures, specific names, and information including various data and parameters illustrated in the specification and drawings can arbitrarily be changed unless otherwise specified. For example, the various types of information illustrated in each of the drawings are not limited to the illustrated information.

Also, each of the components of each of the devices illustrated in the drawings is functionally conceptual, and is not necessarily physically provided as illustrated in the drawings. That is, a specific form of distribution and integration of each device is not limited to the illustrated form, and all or a part thereof can functionally or physically be distributed and integrated in an arbitrary unit according to various loads, usage conditions, and the like.

Also, the above-described embodiments can appropriately be combined in a region in which the processing contents do not contradict each other. Also, the order of the respective steps illustrated in the flowchart in the above-described embodiment can be changed as appropriate.

Furthermore, for example, the present embodiment can be achieved as any configuration constituting a device or a system, such as a processor as a system large scale integration (LSI) or the like, a module using a plurality of processors or the like, a unit using a plurality of modules or the like, and a set obtained by further adding other functions to a unit (that is, a configuration as a part of the device).

Note that, in the present embodiment, the system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Furthermore, for example, the present embodiment can adopt a configuration of cloud computing in which one function is shared and processed by a plurality of devices in cooperation via a network.

### 7. CONCLUSION

Although the embodiments of the present disclosure have been described above, the technical scope of the present disclosure is not limited to the above-described embodiments, and various modifications can be made without departing from the gist of the present disclosure. Also, the components in the different embodiments and modification examples may appropriately be combined.

Further, the effects of the respective embodiments described in the present specification are illustrative only and are not limited, and other effects may be provided.

Note that the present technology can also employ the following configuration.
(1)
A communication device, comprising:
a transceiver; and
a processor that receives, via the transceiver, execution trigger information regarding a trigger for executing a handover, after executing a detachment procedure on a first non-terrestrial station having a first cell, performs an evaluation for the trigger using the execution trigger information, and connects to a second non-terrestrial station having a second cell different from the first cell on a basis of the evaluation.
(2)
The communication device according to (1), wherein a period in which communication with both the first cell and the second cell becomes impossible and a period in which initial connection becomes impossible are included immediately after the detachment procedure is executed on the first non-terrestrial station.
(3)
The communication device according to (1) or (2), wherein the execution trigger information includes at least one of information regarding RSRP of the second cell, information regarding Reference Signal Received Quality (RSRQ) of the second cell, and information regarding Received Signal Strength Indicator (RSSI) of the second cell, and
wherein the evaluation for the trigger is to compare the execution trigger information with at least one of the RSRP of the second cell, the RSRQ of the second cell, and the RSSI of the second cell after executing the detachment procedure on the first non-terrestrial station.
(4)
The communication device according to any one of (1) to (3), wherein coverages of the first cell and the second cell do not overlap with each other.
(5)
The communication device according to any one of (1) to (4), wherein the processor performs the detachment procedure in a case of receiving a detachment execution notification from the first non-terrestrial station.
(6)
The communication device according to any one of (1) to (5), wherein the processor
receives, via the transceiver, detachment execution trigger information regarding a detachment execution trigger for executing the detachment procedure, and
performs an evaluation for the detachment execution trigger using the detachment execution trigger information and executes the detachment procedure on the first non-terrestrial station on a basis of the evaluation.
(7)
The communication device according to (6), wherein the detachment execution trigger information includes at least one of information regarding reception power of a signal transmitted by the first communication station, information regarding time or a timer for executing the detachment procedure, and information regarding execution of the detachment procedure.
(8)
The communication device according to any one of (1) to (7), wherein the processor transmits a detachment request to the first non-terrestrial station.
(9)
The communication device according to any one of (1) to (8), wherein the processor selects the second non-terrestrial station from among one or more communication stations preset as handover target candidates.
(10)
The communication device according to any one of (1) to (9), wherein the execution trigger information includes at least one of information regarding time to start the handover, information regarding time to start the evaluation for the trigger, information regarding an operation after a period in which the handover is performed ends, and information regarding an operation in a case where a synchronization signal from a communication station other than the second non-terrestrial station is received.
(11)
The communication device according to any one of (1) to (10), wherein the communication device receives information regarding a period in which the handover is performed via the transceiver, and
wherein the processor stands by for reception of a synchronization signal from a communication station after the period in which the handover is performed ends.
(12)
The communication device according to any one of (1) to (11), wherein the communication device receives information regarding a period in which the handover is performed via the transceiver, and
wherein the processor discards information regarding the handover after the period in which the handover is performed ends.
(13)
The communication device according to any one of (1) to (12), wherein the processor stands by for reception of a synchronization signal of the second non-terrestrial station in a case of receiving a synchronization signal of a different communication station prior to reception of a synchronization signal of the second non-terrestrial station.
(14)
The communication device according to any one of (1) to (13), wherein the communication device receives information regarding a period in which the handover is performed via the transceiver, and
wherein, in a case where the processor receives a synchronization signal of a different communication station prior to reception of a synchronization signal of the second non-terrestrial station and where the period in which the handover is performed ends, the processor connects to the different communication station.
(15)
The communication device according to any one of (1) to (14), wherein the processor performs one of a handover procedure in which there is one handover target candidate and a handover procedure in which there are a plurality of handover target candidates on a basis of information from the first non-terrestrial station.
(16)
The communication device according to any one of (1) to (15), wherein the processor omits an initial access procedure and connects to the second non-terrestrial station according to information from the first non-terrestrial station.
(17)
The communication device according to any one of (1) to (16), wherein the processor switches between executing the handover which is contention free and executing the handover which is contention based according to at least one of priority of the communication device and priority of data that the communication device transmits or receives.
(18)
A communication device having a first cell and operated as a non-terrestrial station, the communication device comprising:
a transceiver; and
a processor that transmits execution trigger information regarding a trigger for executing a handover via the transceiver to a terminal device and executes a detachment procedure on the terminal device,
wherein, after executing the detachment procedure on the communication device, the terminal device performs an evaluation for the trigger using the execution trigger information, and connects to a second communication device having a second cell different from the first cell on a basis of the evaluation.
(19)
A communication method, comprising:
receiving execution trigger information regarding a trigger for executing a handover; and
after executing a detachment procedure on a first non-terrestrial station having a first cell, performing an evaluation for the trigger using the execution trigger information, and connecting to a second non-terrestrial station having a second cell different from the first cell on a basis of the evaluation.
(20)
A communication method of a communication device having a first cell and operated as a non-terrestrial station, the communication method comprising:
transmitting execution trigger information regarding a trigger for executing a handover to a terminal device; and
executing a detachment procedure on the terminal device,
wherein, after executing the detachment procedure on the communication device, the terminal device performs an evaluation for the trigger using the execution trigger information, and connects to a second communication device having a second cell different from the first cell on a basis of the evaluation.

### REFERENCE SIGNS LIST

1 COMMUNICATION SYSTEM
10 MANAGEMENT DEVICE
20 TERRESTRIAL STATION
30, 50 SATELLITE STATION
40 TERMINAL DEVICE
60 BASE STATION
70 AIRCRAFT STATION
11 COMMUNICATION UNIT
21, 31, 41 RADIO COMMUNICATION UNIT
12, 22, 32, 42 STORAGE UNIT
13, 23, 33, 43 CONTROL UNIT

1. A communication device, comprising:
a transceiver; and
a processor that receives, via the transceiver, execution trigger information regarding a trigger for executing a handover, after executing a detachment procedure on a first non-terrestrial station having a first cell, performs an evaluation for the trigger using the execution trigger information, and connects to a second non-terrestrial station having a second cell different from the first cell on a basis of the evaluation.

2. The communication device according to claim 1, wherein a period in which communication with both the first cell and the second cell becomes impossible and a period in which initial connection becomes impossible are included immediately after the detachment procedure is executed on the first non-terrestrial station.

3. The communication device according to claim 1, wherein the execution trigger information includes at least one of information regarding RSRP of the second cell, information regarding Reference Signal Received Quality (RSRQ) of the second cell, and information regarding Received Signal Strength Indicator (RSSI) of the second cell, and
wherein the evaluation for the trigger is to compare the execution trigger information with at least one of the RSRP of the second cell, the RSRQ of the second cell, and the RSSI of the second cell after executing the detachment procedure on the first non-terrestrial station.

4. The communication device according to claim 1, wherein coverages of the first cell and the second cell do not overlap with each other.

5. The communication device according to claim 1, wherein the processor performs the detachment procedure in a case of receiving a detachment execution notification from the first non-terrestrial station.

6. The communication device according to claim 1, wherein the processor
receives, via the transceiver, detachment execution trigger information regarding a detachment execution trigger for executing the detachment procedure, and
performs an evaluation for the detachment execution trigger using the detachment execution trigger information and executes the detachment procedure on the first non-terrestrial station on a basis of the evaluation.

7. The communication device according to claim 6, wherein the detachment execution trigger information includes at least one of information regarding reception power of a signal transmitted by the first non-terrestrial station, information regarding time or a timer for executing the detachment procedure, and information regarding execution of the detachment procedure.

8. The communication device according to claim 1, wherein the processor transmits a detachment request to the first non-terrestrial station.

9. The communication device according to claim 1, wherein the processor selects the second non-terrestrial station from among one or more communication stations preset as handover target candidates.

10. The communication device according to claim 1, wherein the execution trigger information includes at least one of information regarding time to start the handover, information regarding time to start the evaluation for the trigger, information regarding an operation after a period in which the handover is performed ends, and information regarding an operation in a case where a synchronization signal from a communication station other than the second non-terrestrial station is received.

11. The communication device according to claim 1, wherein the communication device receives information regarding a period in which the handover is performed via the transceiver, and
wherein the processor stands by for reception of a synchronization signal from a communication station after the period in which the handover is performed ends.

12. The communication device according to claim 1, wherein the communication device receives information regarding a period in which the handover is performed via the transceiver, and
wherein the processor discards information regarding the handover after the period in which the handover is performed ends.

13. The communication device according to claim 1, wherein the processor stands by for reception of a synchronization signal of the second non-terrestrial station in a case of receiving a synchronization signal of a different communication station prior to reception of a synchronization signal of the second non-terrestrial station.

14. The communication device according to claim 1, wherein the communication device receives information regarding a period in which the handover is performed via the transceiver, and
wherein, in a case where the processor receives a synchronization signal of a different communication station prior to reception of a synchronization signal of the second non-terrestrial station and where the period in which the handover is performed ends, the processor connects to the different communication station.

15. The communication device according to claim 1, wherein the processor performs one of a handover procedure in which there is one handover target candidate and a handover procedure in which there are a plurality of handover target candidates on a basis of information from the first non-terrestrial station.

16. The communication device according to claim 1, wherein the processor omits an initial access procedure and connects to the second non-terrestrial station according to information from the first non-terrestrial station.

17. The communication device according to claim 1, wherein the processor switches between executing the handover which is contention free and executing the handover which is contention based according to at least one of priority of the communication device and priority of data that the communication device transmits or receives.

18. A communication device having a first cell and operated as a non-terrestrial station, the communication device comprising:
a transceiver; and
a processor that transmits execution trigger information regarding a trigger for executing a handover via the transceiver to a terminal device and executes a detachment procedure on the terminal device,
wherein, after executing the detachment procedure on the communication device, the terminal device performs an evaluation for the trigger using the execution trigger information, and connects to a second communication device having a second cell different from the first cell on a basis of the evaluation.

19. A communication method, comprising:
receiving execution trigger information regarding a trigger for executing a handover; and
after executing a detachment procedure on a first non-terrestrial station having a first cell, performing an evaluation for the trigger using the execution trigger information, and connecting to a second non-terrestrial station having a second cell different from the first cell on a basis of the evaluation.

20. A communication method of a communication device having a first cell and operated as a non-terrestrial station, the communication method comprising:
transmitting execution trigger information regarding a trigger for executing a handover to a terminal device; and
executing a detachment procedure on the terminal device,
wherein, after executing the detachment procedure on the communication device, the terminal device performs an evaluation for the trigger using the execution trigger information, and connects to a second communication device having a second cell different from the first cell on a basis of the evaluation.
